(19) United States
(12) Patent Application Publication
(10) Pub. No.: US 2018/0176588 A1
(43) Pub. Date: Jun. 21, 2018

(54) SCALABLE VIDEO ENCODING/DECODING METHOD AND APPARATUS

(71) Applicant: SAMSUNG ELECTRONICS CO., LTD., Suwon-si (KR)

(72) Inventors: Elena ALSHINA, Suwon-si (KR); Alexander ALSHIN, Suwon-si (KR)

(73) Assignee: SAMSUNG ELECTRONICS CO., LTD., Suwon-si (KR)

(21) Appl. No.: 15/126,005

(22) PCT Filed: Mar. 16, 2015
(86) PCT No.: PCT/KR2015/002532

§ 371 Date: Sep. 14, 2016

Related U.S. Application Data
(60) Provisional application No. 61/953,180, filed on Mar. 14, 2014.

(51) Int. Cl. H04N 19/30; H04N 19/105; H04N 19/186

(52) U.S. Cl. CPC H04N 19/30; H04N 19/186; H04N 19/105

(57) ABSTRACT

Provided is a video decoding method including obtaining, from a bitstream, upsampling phase set information indicating whether a phase of samples comprised in a current layer is adjusted; when the phase is adjusted according to the upsampling phase set information, obtaining a luma vertical phase difference, a luma horizontal phase difference, a chroma vertical phase difference, and a chroma horizontal phase difference from the bitstream; and determining a prediction picture of the current layer by upsampling a reference layer based on the luma vertical phase difference, the luma horizontal phase difference, the chroma vertical phase difference, and the chroma horizontal phase difference, wherein a phase of luma samples comprised in the prediction picture is adjusted according to the luma vertical phase difference and the luma horizontal phase difference, a phase of chroma samples comprised in the prediction picture is adjusted according to the chroma vertical phase difference and the chroma horizontal phase difference, and the luma vertical phase difference and the chroma vertical phase difference are determined according to a scanning scheme with respect to the reference layer.

### TECHNICAL FIELD

The present disclosure relates to video encoding and decoding methods and apparatuses using image upsampling.

### BACKGROUND ART

Conventional image encoding and decoding methods split one picture into macroblocks to encode an image. Thereafter, inter prediction or intra prediction is used to prediction encode each of the macroblocks.

Inter prediction is a method of compressing an image by removing temporal redundancy between pictures and motion estimation encoding is a representative example. Motion estimation encoding predicts each block of a current picture by using at least one reference region. A predetermined evaluation function is used to search for a reference block that is most similar to a current block within a predetermined search range.

The current block is predicted based on the reference block, and a residual block generated by subtracting a prediction block generated as a result of prediction from the current block is encoded. In this regard, in order to further accurately perform prediction, interpolation is performed on the search range of the reference region, sub-samples of a sample unit that is smaller than an integer per unit are generated, and inter prediction is performed based on the generated sub-samples.

### DETAILED DESCRIPTION OF THE INVENTION

### Technical Problem

The present disclosure provides a method of determining, when a prediction picture of a current layer is generated by upsampling a reference layer, a phase of samples included in the prediction picture by using phase difference information, and an apparatus performing the method. The present disclosure also provides a method of determining information for determining the phase difference information, and an apparatus performing the method.

### Technical Solution

According to an aspect of the present disclosure, there is provided a video decoding method including obtaining, from a bitstream, upsampling phase set information indicating whether a phase of samples included in a current layer is adjusted; when the phase is adjusted according to the upsampling phase set information, obtaining a luma vertical phase difference, a luma horizontal phase difference, a chroma vertical phase difference, and a chroma horizontal phase difference from the bitstream; and determining a prediction picture of the current layer by upsampling a reference layer based on the luma vertical phase difference, the luma horizontal phase difference, the chroma vertical phase difference, and the chroma horizontal phase difference.

A phase of luma samples included in the prediction picture may be adjusted according to the luma vertical phase difference and the luma horizontal phase difference, and a phase of chroma samples included in the prediction picture may be adjusted according to the chroma vertical phase difference and the chroma horizontal phase difference.

The luma vertical phase difference and the chroma vertical phase difference may be determined according to a scanning scheme with respect to the reference layer.

The luma vertical phase difference and the chroma vertical phase difference may be determined according to the scanning scheme with respect to the reference layer and an alignment scheme with respect to the reference layer and the current layer, and the alignment scheme may include a zero-phase alignment scheme that involves aligning the reference layer and the current layer, based on top-left portions of the reference layer and the current layer, and a symmetric alignment scheme that involves aligning the reference layer and the current layer, based on a center of the reference layer and the current layer.

The video decoding method may further include obtaining, from the bitstream, reference layer size information, reference layer offset information, current layer size information, and current layer offset information, wherein the reference layer size information indicates a height and width of the reference layer, the reference layer offset information defines a reference region of the reference layer which is used in inter-layer prediction, the current layer size information indicates a height and width of the current layer, and the current layer offset information defines an expanded reference region of the current layer which corresponds to the reference region; determining a size of the reference region from the reference layer size information and the reference layer offset information; determining a size of the expanded reference region from the current layer size information and the current layer offset information; and determining a scale ratio indicating a ratio of the reference region to the expanded reference region, based on the size of the reference region and the size of the expanded reference region, wherein the determining of the prediction picture includes determining the prediction picture by upsampling a reference picture based on the luma vertical phase difference, the luma horizontal phase difference, the chroma vertical phase difference, the chroma horizontal phase difference, the reference layer offset information, the current layer offset information, and the scale ratio.

The video decoding method may further include obtaining, from the bitstream, residual data including a difference value between sample values included in the current layer and sample values included in a reference picture of the current layer; and reconstructing a current picture by using the residual data and the prediction picture.

According to another aspect of the present disclosure, there is provided a video decoding apparatus including a receiving and extracting unit configured to obtain, from a bitstream, upsampling phase set information indicating whether a phase of samples included in a current layer is adjusted, and when the phase is adjusted according to the upsampling phase set information, to obtain a luma vertical phase difference, a luma horizontal phase difference, a chroma vertical phase difference, and a chroma horizontal phase difference from the bitstream; and a decoder configured to determine a prediction picture of the current layer by upsampling a reference layer based on the luma vertical phase difference, the luma horizontal phase difference, the chroma vertical phase difference, and the chroma horizontal phase difference.

A phase of luma samples included in the prediction picture may be adjusted according to the luma vertical phase difference and the luma horizontal phase difference, and a phase of chroma samples included in the prediction picture may be adjusted according to the chroma vertical phase difference and the chroma horizontal phase difference.

The luma vertical phase difference and the chroma vertical phase difference may be determined according to a scanning scheme with respect to the reference layer.

The luma vertical phase difference and the chroma vertical phase difference may be determined according to the scanning scheme with respect to the reference layer and an alignment scheme with respect to the reference layer and the current layer, and the alignment scheme may include a zero-phase alignment scheme that involves aligning the reference layer and the current layer, based on top-left portions of the reference layer and the current layer, and a symmetric alignment scheme that involves aligning the reference layer and the current layer, based on a center of the reference layer and the current layer.

The receiving and extracting unit may be further configured to obtain, from the bitstream, reference layer size information, reference layer offset information, current layer size information, and current layer offset information, wherein the reference layer size information indicates a height and width of the reference layer, the reference layer offset information defines a reference region of the reference layer which is used in inter-layer prediction, the current layer size information indicates a height and width of the current layer, and the current layer offset information defines an expanded reference region of the current layer which corresponds to the reference region, and the decoder may be further configured to determine a size of the reference region from the reference layer size information and the reference layer offset information, to determine a size of the expanded reference region from the current layer size information and the current layer offset information, to determine a scale ratio indicating a ratio of the reference region to the expanded reference region, based on the size of the reference region and the size of the expanded reference region, and to determine the prediction picture by upsampling a reference picture based on the luma vertical phase difference, the luma horizontal phase difference, the chroma vertical phase difference, the chroma horizontal phase difference, the reference layer offset information, the current layer offset information, and the scale ratio.

The receiving and extracting unit may be further configured to obtain, from the bitstream, residual data including a difference value between sample values included in the current layer and sample values included in a reference picture of the current layer, and to reconstruct a current picture by using the residual data and the prediction picture.

According to another aspect of the present disclosure, there is provided a video encoding method including determining a scanning scheme with respect to a current layer and a reference layer; when the current layer is scanned according to a progressive scanning scheme and the reference layer is scanned according to an interlaced scanning scheme, determining a field of the reference layer; determining a luma vertical phase difference, a luma horizontal phase difference, a chroma vertical phase difference, and a chroma horizontal phase difference for adjusting a phase of a luma sample and chroma samples included in a prediction picture of the current layer based on the scanning scheme and the field of the reference layer; determining a prediction picture of the current layer by upsampling the reference layer, based on the luma vertical phase difference, the luma horizontal phase difference, the chroma vertical phase difference, and the chroma horizontal phase difference; determining residual data including difference values between sample values of the current layer and sample values of the prediction picture of the current layer; and outputting a bitstream including the luma vertical phase difference, the luma horizontal phase difference, the chroma vertical phase difference, the chroma horizontal phase difference, and the residual data.

According to another aspect of the present disclosure, there is provided a video encoding apparatus including an encoder configured to determine a scanning scheme with respect to a current layer and a reference layer, when the current layer is scanned according to a progressive scanning scheme and the reference layer is scanned according to an interlaced scanning scheme, to determine a field of the reference layer, to determine a luma vertical phase difference, a luma horizontal phase difference, a chroma vertical phase difference, and a chroma horizontal phase difference for adjusting a phase of a luma sample and chroma samples included in a prediction picture of the current layer based on the scanning scheme and the field of the reference layer, to determine a prediction picture of the current layer by upsampling the reference layer, based on the luma vertical phase difference, the luma horizontal phase difference, the chroma vertical phase difference, and the chroma horizontal phase difference, and to determine residual data including difference values between sample values of the current layer and sample values of the prediction picture of the current layer; and an output unit configured to output a bitstream including the luma vertical phase difference, the luma horizontal phase difference, the chroma vertical phase difference, the chroma horizontal phase difference, and the residual data.

According to another aspect of the present disclosure, there is provided a computer-readable recording medium having recorded thereon a program for executing the video decoding method and the video encoding method.

### Advantageous Effects

When a reference layer is generated by downsampling a current layer during an encoding procedure, a phase of samples included in the current layer is adjusted according to an encoding condition. Equally, when a prediction picture of the current layer is generated by upsampling the reference layer during a decoding procedure, the phase of the samples is adjusted as in the encoding procedure. The phase of the samples is adjusted during a re-sampling process, thus, coding efficiency is increased.

### BRIEF DESCRIPTION OF THE DRAWINGS

FIG. 1A illustrates a block diagram of a scalable video decoding apparatus, according to an embodiment.

FIG. 1B illustrates a flowchart of a scalable video decoding method, according to an embodiment.

FIG. 2A illustrates a block diagram of a scalable video encoding apparatus, according to an embodiment.

FIG. 2B illustrates a flowchart of a scalable video encoding method, according to an embodiment.

FIGS. 3A and 3B illustrate diagrams for describing a luma-chroma phase difference, according to an embodiment.

FIG. 4A is a diagram for describing an interlaced scanning scheme, according to an embodiment.

FIG. 4B is a diagram for describing a reference region, an expanded reference region, and a scale ratio, according to an embodiment.

FIG. 5 illustrates syntax for describing an encoding information obtaining procedure, according to an embodiment.

FIGS. 6A and 6B illustrate block diagrams of a scalable video encoding apparatus 600, according to an embodiment.

FIGS. 7A and 7B illustrate block diagrams of a scalable video decoding apparatus 700, according to an embodiment.

FIG. 8A illustrates a block diagram of a video encoding apparatus based on a coding unit having a tree structure, according to an embodiment.

FIG. 8B illustrates a block diagram of a video decoding apparatus based on a coding unit having a tree structure, according to an embodiment.

FIG. 9 illustrates a diagram for describing a concept of coding units, according to an embodiment.

FIG. 10A illustrates a block diagram of an image encoder based on coding units, according to an embodiment.

FIG. 10B illustrates a block diagram of an image decoder based on coding units, according to an embodiment.

FIG. 11 illustrates a diagram illustrating deeper coding units according to depths, and partitions, according to an embodiment.

FIG. 12 illustrates a diagram for describing a relationship between a coding unit and transformation units, according to an embodiment.

FIG. 13 illustrates a plurality of pieces of encoding information according to depths, according to an embodiment.

FIG. 14 illustrates coding units according to depths, according to an embodiment.

FIGS. 15, 16, and 17 illustrate relationships between coding units, prediction units, and transformation units, according to an embodiment.

FIG. 18 illustrates a relationship between a coding unit, a prediction unit, and a transformation unit, according to encoding mode information of Table 1.

FIG. 19 illustrates a physical structure of a disc in which a program is stored, according to an embodiment.

FIG. 20 illustrates a disc drive for recording and reading a program by using the disc.

FIG. 21 illustrates an entire structure of a content supply system for providing a content distribution service.

FIGS. 22 and 23 illustrate external and internal structures of a mobile phone to which the video encoding method and the video decoding method are applied, according to an embodiment.

FIG. 24 illustrates a digital broadcasting system employing a communication system, according to an embodiment.

### BEST MODE

Provided is a video decoding method including obtaining, from a bitstream, upsampling phase set information indicating whether a phase of samples included in a current layer is adjusted; when the phase is adjusted according to the upsampling phase set information, obtaining a luma vertical phase difference, a luma horizontal phase difference, a chroma vertical phase difference, and a chroma horizontal phase difference from the bitstream; and determining a prediction picture of the current layer by upsampling a reference layer based on the luma vertical phase difference, the luma horizontal phase difference, the chroma vertical phase difference, and the chroma horizontal phase difference. A phase of luma samples included in the prediction picture may be adjusted according to the luma vertical phase difference and the luma horizontal phase difference, and a phase of chroma samples included in the prediction picture is adjusted according to the chroma vertical phase difference and the chroma horizontal phase difference. The luma vertical phase difference and the chroma vertical phase difference may be determined according to a scanning scheme with respect to the reference layer.

Provided is a video decoding apparatus including a receiving and extracting unit configured to obtain, from a bitstream, upsampling phase set information indicating whether a phase of samples included in a current layer is adjusted, and when the phase is adjusted according to the upsampling phase set information, to obtain a luma vertical phase difference, a luma horizontal phase difference, a chroma vertical phase difference, and a chroma horizontal phase difference from the bitstream; and a decoder configured to determine a prediction picture of the current layer by upsampling a reference layer based on the luma vertical phase difference, the luma horizontal phase difference, the chroma vertical phase difference, and the chroma horizontal phase difference. A phase of luma samples included in the prediction picture may be adjusted according to the luma vertical phase difference and the luma horizontal phase difference, and a phase of chroma samples included in the prediction picture may be adjusted according to the chroma vertical phase difference and the chroma horizontal phase difference. The luma vertical phase difference and the chroma vertical phase difference may be determined according to a scanning scheme with respect to the reference layer.

Provided is a video encoding method including determining a scanning scheme with respect to a current layer and a reference layer; when the current layer is scanned according to a progressive scanning scheme and the reference layer is scanned according to an interlaced scanning scheme, determining a field of the reference layer; determining a luma vertical phase difference, a luma horizontal phase difference, a chroma vertical phase difference, and a chroma horizontal phase difference for adjusting a phase of a luma sample and chroma samples included in a prediction picture of the current layer based on the scanning scheme and the field of the reference layer; determining a prediction picture of the current layer by upsampling the reference layer, based on the luma vertical phase difference, the luma horizontal phase difference, the chroma vertical phase difference, and the chroma horizontal phase difference; determining residual data including difference values between sample values of the current layer and sample values of the prediction picture of the current layer; and outputting a bitstream including the luma vertical phase difference, the luma horizontal phase difference, the chroma vertical phase difference, the chroma horizontal phase difference, and the residual data.

Provided is a video encoding apparatus including an encoder configured to determine a scanning scheme with respect to a current layer and a reference layer, when the current layer is scanned according to a progressive scanning scheme and the reference layer is scanned according to an interlaced scanning scheme, to determine a field of the reference layer, to determine a luma vertical phase difference, a luma horizontal phase difference, a chroma vertical phase difference, and a chroma horizontal phase difference for adjusting a phase of a luma sample and chroma samples included in a prediction picture of the current layer based on the scanning scheme and the field of the reference layer, to determine a prediction picture of the current layer by upsampling the reference layer, based on the luma vertical phase difference, the luma horizontal phase difference, the chroma vertical phase difference, and the chroma horizontal phase difference, and to determine residual data including difference values between sample values of the current layer and sample values of the prediction picture of the current layer; and an output unit configured to output a bitstream including the luma vertical phase difference, the luma horizontal phase difference, the chroma vertical phase difference, the chroma horizontal phase difference, and the residual data.

### MODE OF THE INVENTION

Hereinafter, in various embodiments described in the present specification, the term ‘image’ may collectively refer to not only a still image but also refer to a moving picture such as a video. The term ‘picture’ described in the present specification refers to a still image to be encoded or decoded.

A scalable coding scheme refers to a method of hierarchically coding one image to make the image be eligible for various resolutions, frame rates, image qualities, or the like. Since one bitstream includes the image having various resolutions, frame rates, image qualities, or the like, a content user may extract a part of the bitstream and may reproduce an image satisfying a user-desired resolution, frame rate, image quality, or the like.

The image coded according to the scalable coding scheme has at least two layers. Each layer has at least one of an upper layer and a lower layer.

A layer may be classified into a current layer and a reference layer. The current layer indicates an upper layer of the reference layer, the upper layer being encoded/decoded by referring to pictures of the reference layer. The reference layer indicates a lower layer of the current layer, the lower layer providing the pictures required in encoding/decoding of the current layer. For example, a resolution, a frame rate, and an image quality of the pictures of the reference layer are inferior to those of pictures of the current layer.

The current layer and the reference layer are a relative concept. For example, when a first layer, a second layer, and a third layer are present in an order starting from an upper layer, the second layer may become a reference layer with respect to the first layer. Conversely, the second layer may become a current layer with respect to the third layer.

In general, the current layer is used along with the term ‘enhancement layer’. The reference layer is used along with the term ‘base layer’. Therefore, the enhancement layer used in the present specification has the same meaning as the current layer. Equally, the base layer used in the present specification has the same meaning as the reference layer.

In the present specification, re-sampling refers to a procedure of re-determining the number and attributes of samples that construct a picture. The re-sampling includes downsampling and upsampling.

In the present specification, downsampling refers to a procedure of decreasing the number of pixels that construct a picture. For example, when the number of pixels constructing the picture is 32×32, a downsampled picture of which the number of pixels is 16×16 may be obtained by the downsampling. A ratio of pixels that are decreased due to the downsampling may vary according to embodiments.

In the present specification, on the contrary to the downsampling, upsampling refers to a procedure of increasing the number of pixels that construct a picture. For example, when the number of pixels constructing the picture is 16×16, an upsampled picture of which the number of pixels is 32×32 may be obtained by the upsampling. A ratio of pixels that are increased due to the upsampling may vary according to embodiments.

In the present specification, the downsampling and the upsampling may be used in terms of a resolution, a reference layer may be generated by downsampling a current layer, and a prediction picture of the current layer may be obtained by upsampling the reference layer.

In the present specification, an offset refers to displacement between an entire region of a layer defined based on luma sample units and a portion of the layer which is to be upsampled or downsampled. A horizontal offset indicates horizontal-direction displacement. A vertical offset indicates vertical-direction displacement. A unit of an offset is defined in a manner that an interval between horizontally-neighboring or vertically-neighboring luma samples is 1. For example, when a pixel B is 4 pixels to the right and 2 pixels down from a pixel A, a horizontal offset of the pixel B with respect to the pixel A is 4, and a vertical offset of the pixel B is 2.

In the present specification, a phase refers to displacement between samples. The phase may include a vertical or horizontal component. In the present specification, when a location of a sample is adjusted during an upsampling process or a downsampling process, a phase difference refers to displacement of the sample before the adjustment and a sample after the adjustment. The phase difference may be expressed only as an integer. For example, when a distance between samples that are horizontally or vertically adjacent to each other is 16, the accuracy at which the phase difference may be expressed is 1/16 of a distance between samples that are horizontally adjacent to each other.

When an original image is encoded according to a scalable encoding scheme, a phase of luma samples and chroma samples may be adjusted to increase encoding efficiency during the downsampling and upsampling processes. In decoding operations, as in the encoding operations, a phase of luma samples and chroma samples are adjusted in the upsampling process. Therefore, when a current layer is upsampled during the decoding procedure, information regarding a phase that was adjusted when an original image was downsampled and upsampled during the encoding procedure is required.

Therefore, in the present specification, a method of determining a phase of samples during the upsampling process is described below. In more detail, various embodiments of the present specification provide a method and apparatus for changing a phase of a luma sample and chroma sample during a decoding procedure by using information regarding a phase changed according to an alignment scheme of a reference layer and current layer and a scanning scheme of the reference layer. Also, in the present specification, all processes related to a change in a phase which occur during an upsampling process are described below.

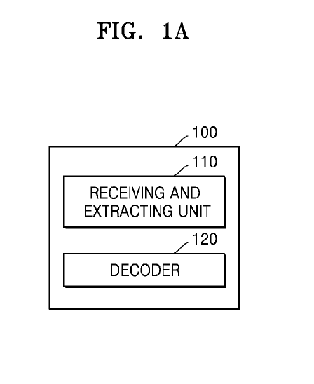

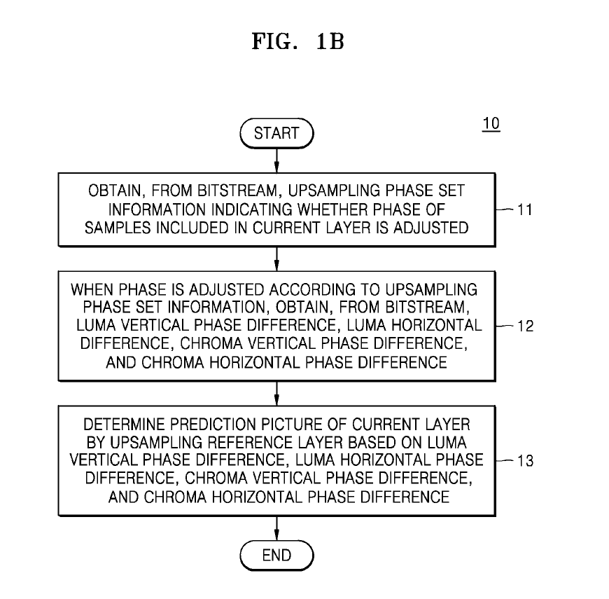

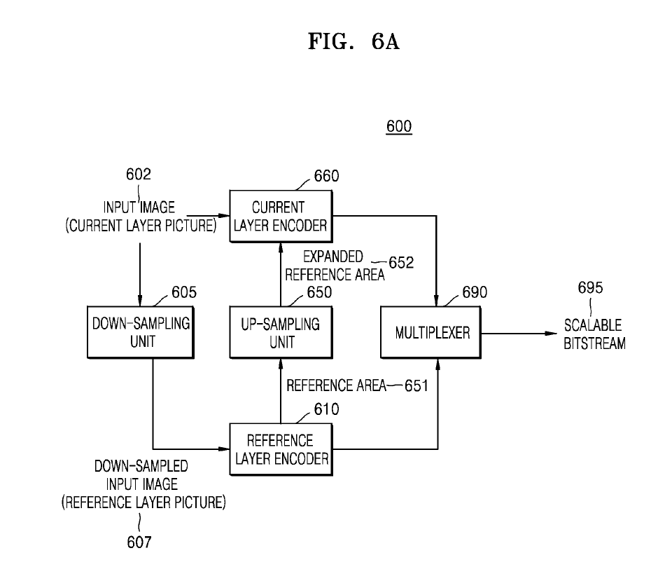

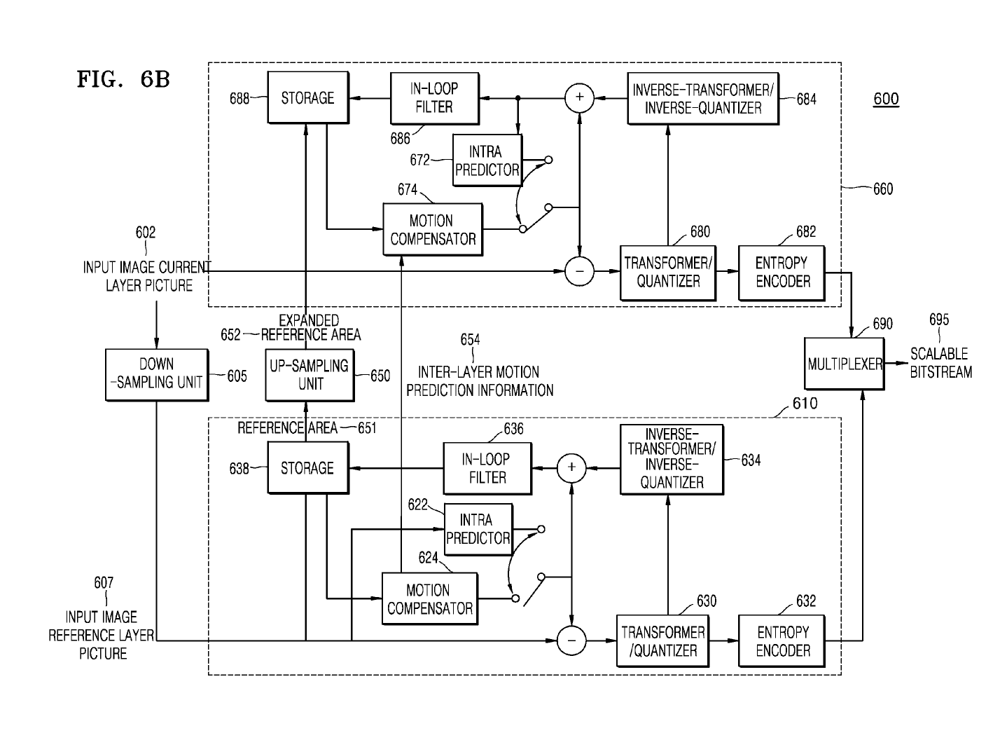

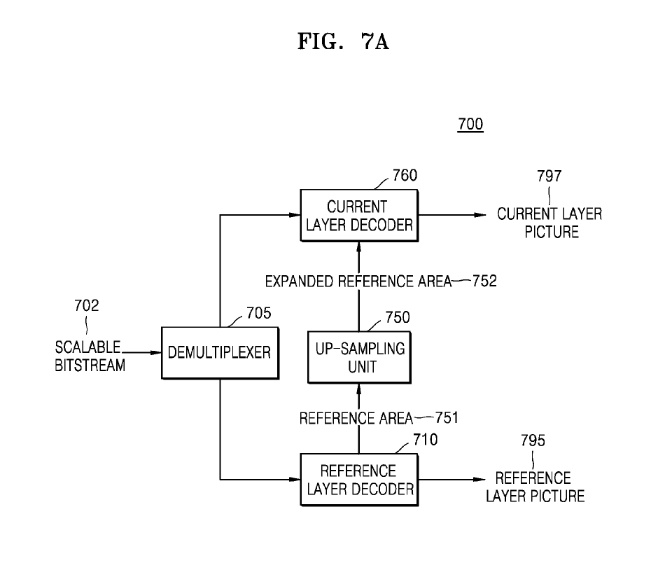

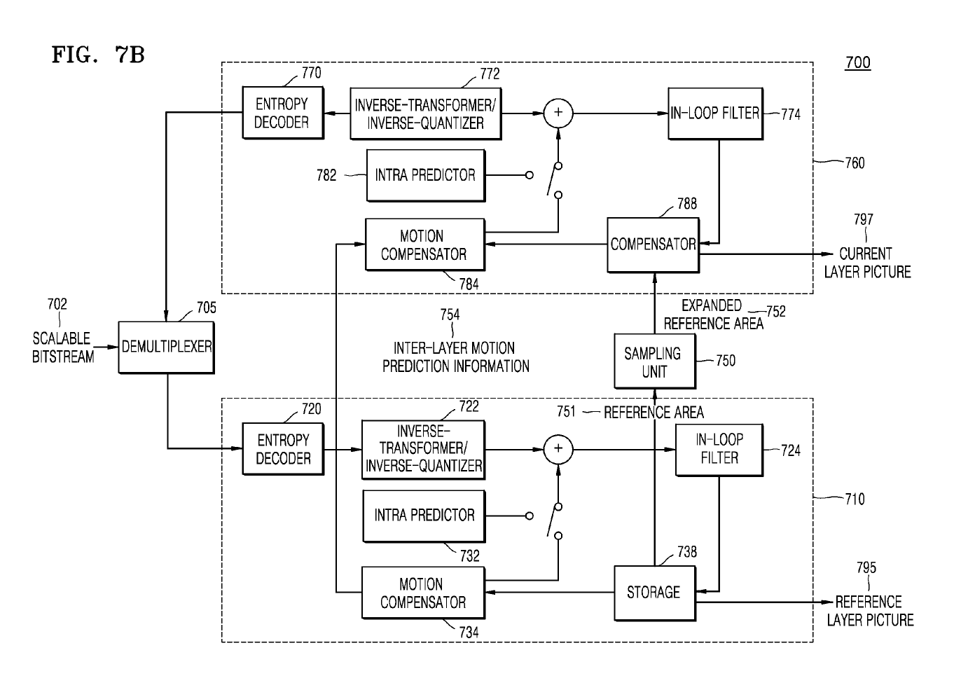

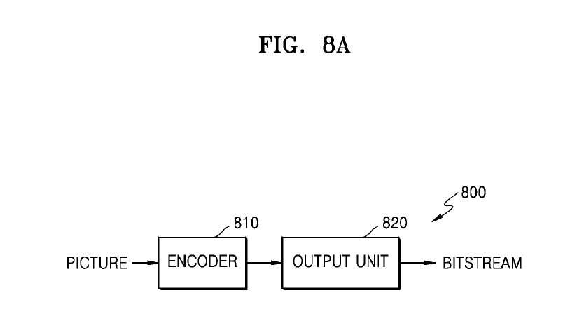

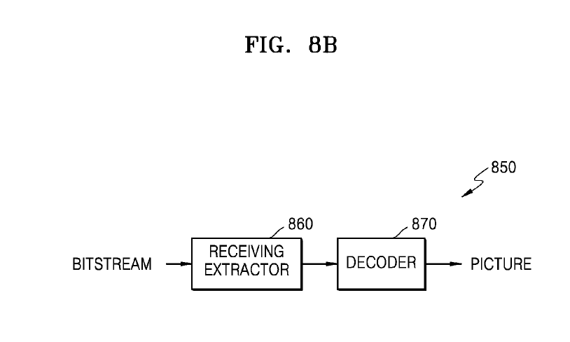

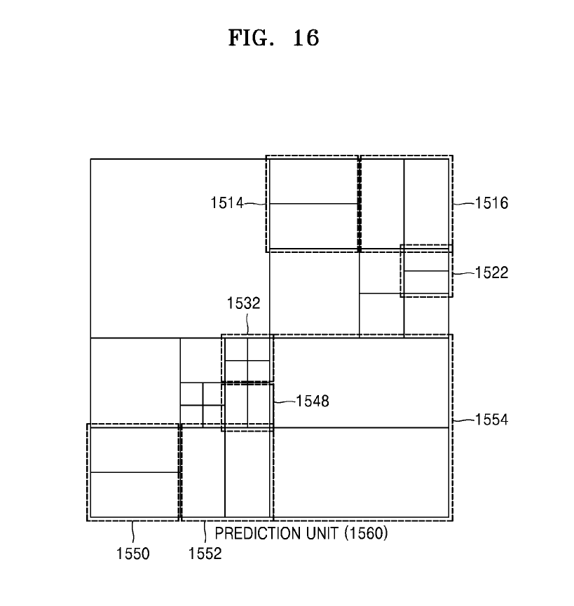

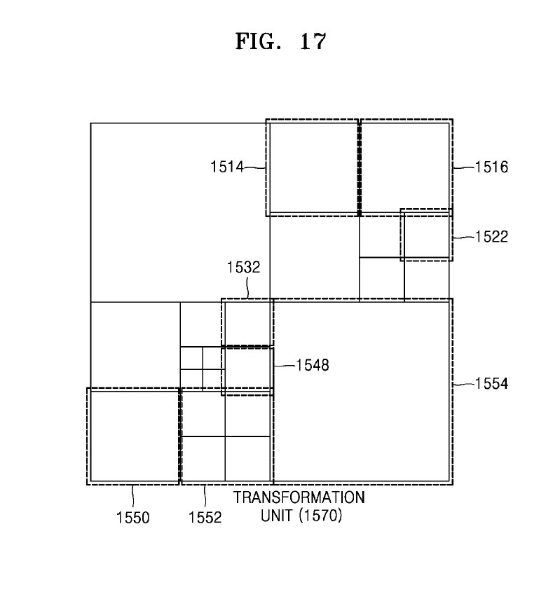

Hereinafter, with reference to FIGS. 1A through 5, upsampling of an image, which is performed by taking into account an offset of a reference layer and current layer, is proposed below. Also, with reference to FIGS. 6A through 7B, scalable video encoding and decoding using upsampling in consideration of an offset of a reference layer and current layer are proposed below. Hereinafter, with reference to FIGS. 8 through 18, video encoding and decoding based on coding units according to a tree structure, which are performed in each layer of a scalable video system, are proposed.

Hereinafter, with reference to FIGS. 1A through 5, image upsampling performed by taking into account an offset of a reference layer and current layer according to various embodiments is described in detail.

FIG. 1A illustrates a block diagram of a scalable video decoding apparatus 100, according to an embodiment.

The scalable video decoding apparatus 100 may include a receiving and extracting unit 110 and a decoder 120. Referring to FIG. 1A, the receiving and extracting unit 110 and the decoder 120 are illustrated as separate elements, but in another embodiment, the receiving and extracting unit 110 and the decoder 120 may be combined and thus may be implemented as one element.

Referring to FIG. 1A, the receiving and extracting unit 110 and the decoder 120 are illustrated as elements in one apparatus, but apparatuses respectively performing functions of the receiving and extracting unit 110 and the decoder 120 may not be physically adjacent to each other. Therefore, in another embodiment, the receiving and extracting unit 110 and the decoder 120 may be dispersed.

The receiving and extracting unit 110 and the decoder 120 of FIG. 1A may be implemented by one processor in an embodiment. In another embodiment, they may be implemented by a plurality of processors.

The scalable video decoding apparatus 100 may include a storage (not shown) to store data generated by the receiving and extracting unit 110 and the decoder 120. In addition, the receiving and extracting unit 110 and the decoder 120 may extract stored data from the storage (not shown) and may use the data.

The scalable video decoding apparatus 100 of FIG. 1A is not limited to a physical apparatus. For example, some function among functions of the scalable video decoding apparatus 100 may not be implemented as hardware but may be implemented as software.

The receiving and extracting unit 110 may obtain upsampling phase set information. The upsampling phase set information indicates whether a phase of samples included in a current layer is adjusted during an upsampling process. The upsampling phase set information may have a value of 0 or 1. For example, if the upsampling phase set information indicates 1, the phase of the samples included in the current layer is adjusted. On the other hand, if the upsampling phase set information indicates 0, the phase of the samples included in the current layer is not adjusted. As another example opposite to the example, if alignment scheme specifying information indicates 0, the phase of the samples included in the current layer may be adjusted.

When the upsampling phase set information indicates that the phase of the samples is adjusted, the receiving and extracting unit 110 may obtain a luma vertical phase difference, a luma horizontal phase difference, a chroma vertical phase difference, and a chroma horizontal phase difference from a bitstream.

The luma vertical phase difference indicates how far a phase of luma samples is changed in a vertical direction. The luma horizontal phase difference indicates how far the phase of the luma samples is changed in a horizontal direction. The chroma vertical phase difference indicates how far a phase of chroma samples is changed in a vertical direction. The chroma horizontal phase difference indicates how far the phase of the chroma samples is changed in a horizontal direction.

The luma vertical phase difference, the luma horizontal phase difference, the chroma vertical phase difference, and the chroma horizontal phase difference may be determined in an encoding procedure. Hereinafter, a method of determining the luma vertical phase difference, the luma horizontal phase difference, the chroma vertical phase difference, and the chroma horizontal phase difference will now be described.

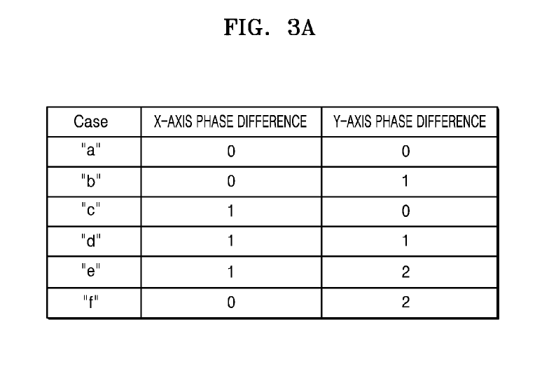

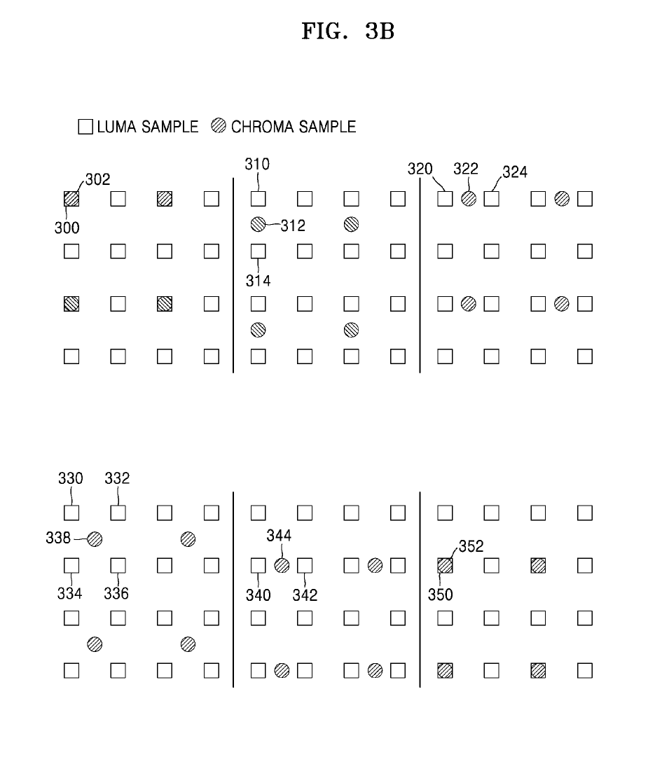

The chroma vertical phase difference and the chroma horizontal phase difference may be determined based on a vertical luma-chroma phase difference and a horizontal luma-chroma phase difference. The vertical luma-chroma phase difference indicates a vertical-direction phase difference between a luma sample and a chroma sample. The horizontal luma-chroma phase difference indicates a horizontal-direction phase difference between the luma sample and the chroma sample. With reference to FIGS. 3A and 3B, the vertical luma-chroma phase difference and the horizontal luma-chroma phase difference are described below.

FIG. 3A illustrates 6 cases according to a vertical luma-chroma phase difference and a horizontal luma-chroma phase difference. FIG. 3B illustrates the cases of FIG. 3A with respect to locations of chroma samples which are relative to those of luma samples when a color format is 4:2:0. In FIG. 3A, an X-axis phase difference refers to the horizontal luma-chroma phase difference, and a Y-axis phase difference refers to the vertical luma-chroma phase difference. In FIG. 3B, a square symbol indicates a luma sample, and a round symbol indicates a chroma symbol.

The vertical luma-chroma phase difference and the horizontal luma-chroma phase difference may each have a value between 0 through 2. In another embodiment, they have a value different from the value between 0 through 2.

When the color format is 4:2:0, one chroma sample corresponds to a 2×2 luma sample grid consisting of 4 luma samples. If a phase difference between a luma sample and a chroma sample is not present, the chroma sample is located at a luma sample located at a top-left location of the 2×2 luma sample grid.

In FIG. 3B, a distance between luma samples that are vertically or horizontally adjacent to each other is defined as 2. For example, if, as in the second case, a chroma sample 312 is moved from a location of a luma sample 310 to a median location between the luma sample 310 and a luma sample 314, the vertical luma-chroma phase difference is 1.

In the first case, the horizontal luma-chroma phase difference and the vertical luma-chroma phase difference are each 1. Since a phase difference between the luma sample and the chroma sample is not present, a chroma sample 302 is located at a luma sample located at a top-left location of a 2×2 luma sample grid.

In the second case, the horizontal luma-chroma phase difference is 0 and the vertical luma-chroma phase difference is 1. Therefore, the chroma sample 312 is located at a median location between the top-left luma sample 310 and the bottom-left luma sample 314 in a 2×2 luma sample grid.

In the third case, the horizontal luma-chroma phase difference is 1 and the vertical luma-chroma phase difference is 0. Therefore, the chroma sample is located at a median location between a top-left luma sample 320 and a top-right luma sample 324 in a 2×2 luma sample grid.

In the fourth case, the horizontal luma-chroma phase difference and the vertical luma-chroma phase difference are each 1. Therefore, a chroma sample 338 is located at a center among four luma samples 330, 332, 334, and 336.

In the fifth case, the horizontal luma-chroma phase difference is 1 and the vertical luma-chroma phase difference is 2. Therefore, a chroma sample 344 is located between a bottom-left luma sample 340 and a bottom-right luma sample 342 in a 2×2 luma sample grid.

In the sixth case, the horizontal luma-chroma phase difference is 0 and the vertical luma-chroma phase difference is 2. Therefore, a chroma sample 352 is located at the location of the bottom-left luma sample 350 in a 2×2 luma sample grid.

The chroma vertical phase difference and the chroma horizontal phase difference may be determined by using the determined vertical luma-chroma phase difference and horizontal luma-chroma phase difference. Since the vertical luma-chroma phase difference and the horizontal luma-chroma phase difference indicate a phase change of the chroma sample relative to the luma sample, a luma vertical phase difference and a luma horizontal phase difference are not changed. For example, when the vertical luma-chroma phase difference is 1 and the horizontal luma-chroma phase difference is 2, a phase change of the luma sample due to the vertical luma-chroma phase difference and the horizontal luma-chroma phase difference does not occur. However, due to the vertical luma-chroma phase difference and the horizontal luma-chroma phase difference, a phase of the chroma sample is changed by 1 to the bottom and 2 to the left.

The luma vertical phase difference, the luma horizontal phase difference, the chroma vertical phase difference, and the chroma horizontal phase difference may be aligned according to an alignment scheme indicating alignments of a reference layer and a current layer. The alignment scheme includes a zero-phase alignment scheme and a symmetric alignment scheme.

The zero-phase alignment scheme involves aligning samples of the reference layer and the current layer, based on top-left samples of the reference layer or the current layer. For example, when a luma sample and a chroma sample are aligned based on the zero-phase alignment scheme, as in the first case of FIG. 3B, the chroma sample is located at a top-left luma sample among 4 luma samples. Thus, when samples are aligned based on the zero-phase alignment scheme and a color format is 4:2:0, the chroma sample is already located at a location of the top-left luma sample in a 2×2 luma sample grid, thus, a phase change of the samples due to an alignment scheme does not occur.

The symmetric alignment scheme involves aligning samples of the reference layer and the current layer, based on a center of the reference layer and the current layer. When the samples are aligned based on the symmetric alignment scheme, arrangement of the samples is symmetrical with respect to the center. Therefore, when the symmetric alignment scheme is applied thereto, a phase of the luma sample and the chroma sample is adjusted.

The luma vertical phase difference and the chroma vertical phase difference may be determined based on a scanning scheme of the current layer and the reference layer and a field of the reference layer.

The scanning scheme includes a progressive scanning scheme and an interlaced scanning scheme.

The progressive scanning scheme refers to a way of displaying, storing, and transmitting an image in which one picture is included in one frame. Therefore, each frame of the image corresponds to a complete picture. For example, when a picture is obtained every 1/30 seconds, 30 frames that correspond to 30 pictures per second are generated. An image of 30 frames per second, which is generated based on the progressive scanning scheme, is displayed as 30p.

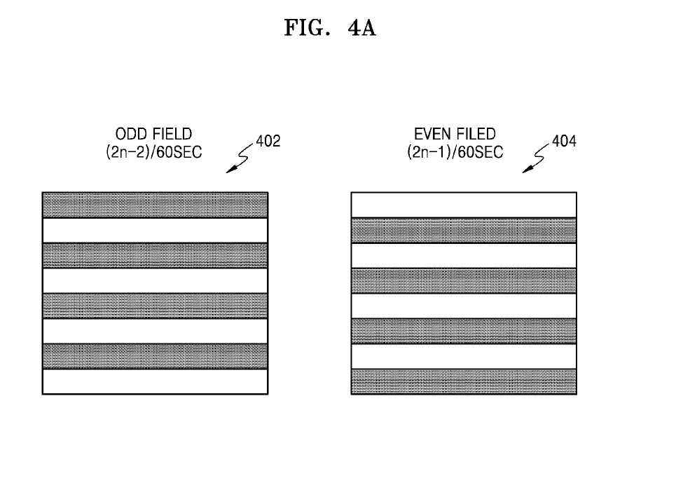

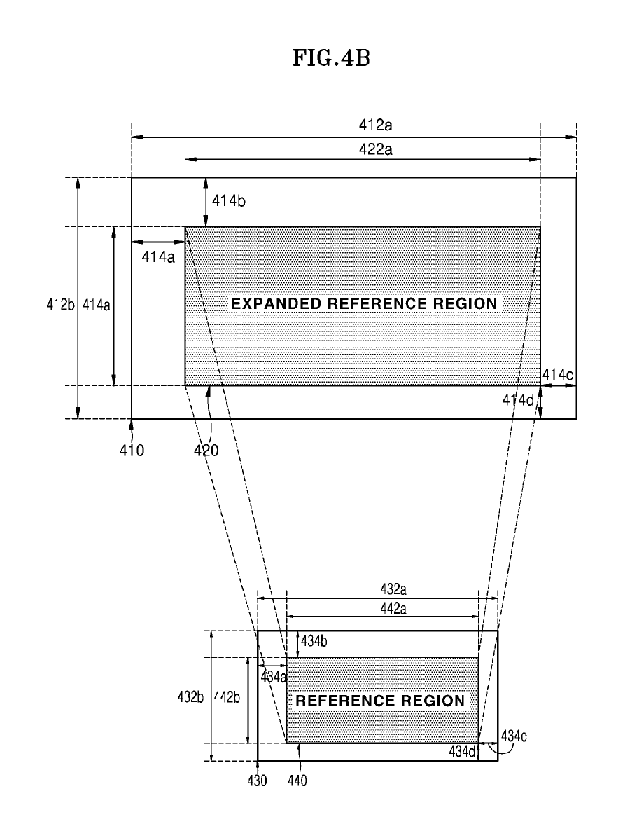

On the other hand, the interlaced scanning scheme refers to a way of displaying, storing, and transmitting an image in which an odd field or an even field of one picture is included in one frame. The odd field only includes samples located at an odd line from among samples that construct a picture. The even field only includes samples located at an even line from among the samples that construct the picture. A frame including the odd field and a frame including the even field are reproduced in an interlaced manner as if a complete picture is reproduced. FIG. 4A is a diagram for particularly describing features of the interlaced scanning scheme.

In FIG. 4A, a frame 402 including an odd field is displayed at the left side, and a frame 404 including an even field is displayed at the right side. Lines with a gray color indicate sample lines where samples to be scanned are present. On the other hand, lines with a white color indicate sample lines where samples to be scanned are not present. In FIG. 4A, n is an integer equal to or greater than 1.

Referring to FIG. 4A, only odd lines are gray-marked in the frame 402 including the odd field. Therefore, it is possible to recognize that samples to be scanned are located only in the odd lines in the frame 402 including the odd field. On the other hand, only even lines are gray-marked in the frame 404 including the even field. Therefore, it is possible to recognize that samples to be scanned are located only in the even lines in the frame 404 including the even field.

Referring to FIG. 4A, the frame 402 includes only the odd field of pictures obtained at (2n−2)/60 seconds. The frame 404 includes only the even field of pictures obtained at (2n−1)/60 seconds. Therefore, the frame 402 including the odd field and the frame 404 including the even field are displayed, stored, and transmitted in an interlaced manner. An image of 60 frames per second, which is generated based on the interlaced scanning scheme as shown in FIG. 4A, is expressed as 60i.

Before image encoding, a data amount of one frame of an image generated based on the interlaced scanning scheme is a half of a data amount of one frame of an image generated based on the progressive scanning scheme. Therefore, a data amount of an image generated at 60 frames per second based on the interlaced scanning scheme is a half of a data amount of an image generated at 60 frames per second based on the progressive scanning scheme. Accordingly, the interlaced scanning scheme requires less data amount.

However, since an image based on the progressive scanning scheme reproduces a frame including a complete picture, the image may provide good quality compared to an image based on the interlaced scanning scheme.

When a current layer and a reference layer are all scanned according to the progressive scanning scheme, since one complete picture corresponds to one frame, a phase change due to a scanning scheme is not required. However, as shown in FIG. 4A, according to the interlaced scanning scheme, only an even scan line (an even field) or an odd scan line (an odd field) is displayed per one frame, therefore, if the current layer is scanned based on the progressive scanning scheme and the reference layer is scanned based on the interlaced scanning scheme, adjustment of a luma vertical phase difference and a chroma vertical phase difference is required. In particular, when a displayed frame of the reference layer includes an even field, locations of samples of the frame including the even field have to be adjusted to prevent a region displayed in an odd field from overlapping with a region displayed in the even field.

Therefore, in a case where the current layer is scanned based on the progressive scanning scheme, the reference layer is scanned based on the interlaced scanning scheme, and a field of the reference layer is the even field, the luma vertical phase difference and the chroma vertical phase difference are adjusted.

Equation 1 and Equation 2 below are equations for determining a vertical phase difference and a horizontal phase difference, based on a scanning scheme. An encoder 210 of a scalable video encoding apparatus 200 to be described below may determine the vertical phase difference and the horizontal phase difference by using Equation 1 and Equation 2.

phaseX=(cIdx==0)?(cross_layer_phase_alignment_flag<<1):cross_layer_phase_alignment_flag [Equation 1]

phaseY=VertPhasePositionAdjustFlag?((VertPhasePositionFlag<<2):(cIdx==0)?(cross_layer_phase_alignment_flag<<1):(cross_layer_phase_alignment_flag+1)) [Equation 2]

In Equation 1 and Equation 2, ‘<<’ indicates a right shift operator. In more detail, ‘(bitstream)<<(N)’ is interpreted to add an N number of 0s to the right side of ‘bitstream’. For example, ‘11<<2’ is interpreted as ‘1100’.

‘?’ indicates a condition operator. In more detail, in a case of a structure ‘(condition)? (Calculation 1):(Calculation 2)’, if the condition is true, a result value complies with Calculation 1, and if the condition is false, the result value complies with Calculation 2.

The operators are equally applied to Equations provided in the specification.

In Equation 1 and Equation 2, phaseX refers to a horizontal phase difference, and phaseY refers to a vertical phase difference. cIdx refers to a color component index, and cross_layer_phase_alignment_flag refers to alignment scheme specifying information. In addition, VertPhasePositionAdjustFlag refers to scanning scheme specifying information, and VertPhasePositionFlag refers to field specifying information.

When a phase difference with respect to a luma sample is determined, a color component index is determined to be 0. When a phase difference with respect to Cb and Cr that are chroma samples are determined, a color component index is determined to be 1 or 2.

When the current layer and the reference layer are based on the zero-phase alignment scheme, the alignment scheme specifying information is determined to be 0. When the current layer and the reference layer are based on the symmetric alignment scheme, the alignment scheme specifying information is determined to be 1.

When the progressive scanning scheme is applied to all of the current layer and the reference layer, the scanning scheme specifying information is determined to be 0. When the progressive scanning scheme is applied to the current layer, and the interlaced scanning scheme is applied to the reference layer, the scanning scheme specifying information is determined to be 1.

The field specifying information is determined when the scanning scheme specifying information is determined to be 1. When the reference layer includes an odd field, the field specifying information is determined to be 0. When the reference layer includes an even field, the field specifying information is determined to be 1.

Regarding Equation 1, a value of the color component index is first determined. When the value of the color component index is 0, cross_layer_phase_alignment_flag<<1 is calculated to determine a horizontal phase difference with respect to a luma sample. If the alignment scheme specifying information is 1, the horizontal phase difference with respect to the luma sample is determined to be 2, and if the alignment scheme specifying information is 0, the horizontal phase difference with respect to the luma sample is determined to be 0.

When the value of the color component index is 1 or 2, cross_layer_phase_alignment_flag is calculated to determine a horizontal phase difference with respect to a chroma sample. If the alignment scheme specifying information is 1, the horizontal phase difference with respect to the luma sample is determined to be 1, and if the alignment scheme specifying information is 0, the horizontal phase difference with respect to the luma sample is determined to be 0.

Regarding Equation 2, the scanning scheme specifying information is first interpreted. When the scanning scheme specifying information is 1, it is determined that the progressive scanning scheme is applied to the current layer, and the interlaced scanning scheme is applied to the reference layer. When the scanning scheme specifying information is 1, VertPhasePositionFlag<<2 is calculated to obtain a vertical phase difference. If the scanning scheme specifying information is 1, a horizontal phase difference with respect to a luma sample is determined to be 4, and if the scanning scheme specifying information is 0, the horizontal phase difference with respect to the luma sample is determined to be 0.

If the scanning scheme specifying information is 1, it is determined that the progressive scanning scheme is applied to all of the current layer and the reference layer. Then, a value of a color component index is determined.

When the value of the color component index is 0, cross_layer_phase_alignment_flag<<1 is calculated to determine a vertical phase difference with respect to a luma sample. If the alignment scheme specifying information is 1, the vertical phase difference with respect to the luma sample is determined to be 2, and if the alignment scheme specifying information is 0, the vertical phase difference with respect to the luma sample is determined to be 0.

When the value of the color component index is 1 or 2, cross_layer_phase_alignment_flag+1 is calculated to determine the vertical phase difference with respect to the chroma sample. If the alignment scheme specifying information is 1, the vertical phase difference with respect to the luma sample is determined to be 2 and if the alignment scheme specifying information is 0, the vertical phase difference with respect to the luma sample is determined to be 1

The receiving and extracting unit 110 may obtain reference layer size information, reference layer offset information, current layer size information, and current layer offset information from a bitstream.

In the present specification, a reference region refers to a region of a picture of a reference layer, the region being used in inter-layer prediction. An entire region of the reference layer may be determined as the reference region. In another embodiment, only a portion of the reference layer may be determined as the reference region.

According to tree-structure encoding/decoding methods, encoding/decoding operations are performed on a picture in coding units. Since a smallest coding unit is 8×8, if a resolution of the reference layer and the current layer is not a multiple of 8, upsampling cannot be performed fast. Therefore, when the resolution of the reference layer is not a multiple of 8, a reference region of which resolution is a multiple of 8 may be set in the reference layer. Equally, when the resolution of the current layer is not a multiple of 8, an expanded reference region of which resolution is a multiple of 8 may be set in the current layer.

In the present specification, the expanded reference region indicates a region of a picture generated by upsampling a reference region. As described above, since a resolution of the current layer picture is higher than a resolution of the reference layer picture, the resolution of the current layer picture is higher than a resolution of the reference region that is a portion of the reference layer picture. Therefore, it is difficult to predict the high-resolution current layer picture by using the low-resolution reference region. Therefore, the current layer picture is predicted by using the expanded reference region having an increased resolution by upsampling the reference region. Similar to the reference region, an entire area of the current layer may be determined as the expanded reference region. However, in another embodiment, only a portion of the current layer may be determined as the expanded reference region.

The reference region is determined based on the reference layer size information and the reference layer offset information. The reference layer size information indicates information regarding a height and width of the reference layer picture. The reference layer offset information indicates an offset between the reference layer picture and the reference region.

The reference layer offset information may include a reference layer left offset, a reference layer right offset, a reference layer top offset, and a reference layer bottom offset.

The reference layer left offset is a horizontal offset between a luma sample in an upper left area of the reference layer picture and a luma sample in an upper left area of the reference region. The reference layer top offset is a vertical offset between the luma sample in the upper left area of the reference layer picture and the luma sample in the upper left area of the reference region.

The reference layer right offset is a horizontal offset between a luma sample in a bottom-right area of the reference layer picture and a luma sample in a bottom-right area of the reference region, and the reference layer bottom offset is a vertical offset between the luma sample in the bottom-right area of the reference layer picture and the luma sample in the bottom-right area of the reference region.

The expanded reference region is determined based on the current layer size information and the current layer offset information. The current layer size information indicates information regarding the height and width of the current layer picture. The current layer offset information indicates an offset between the current layer picture and the current picture.

The current layer offset information may include a current layer left offset, a current layer right offset, a current layer top offset, and a current layer bottom offset.

The current layer left offset is a horizontal offset between a luma sample in an upper left area of the current layer picture and a luma sample in an upper left area of the expanded reference region. The current layer top offset is a vertical offset between the luma sample in the upper left area of the current layer picture and the luma sample in the upper left area of the expanded reference region.

The current layer right offset is a horizontal offset between a luma sample in a bottom-right area of the current layer picture and a luma sample in a bottom-right area of the expanded reference region, and the current layer bottom offset is a vertical offset between the luma sample in the bottom-right area of the current layer picture and the luma sample in the bottom-right area of the expanded reference region.

The reference layer offset information and the current layer offset information may be expressed as luma sample units. For example, when the reference layer left offset is 4 and the reference layer top offset is 2, a luma sample that is 4 samples to the right and 2 samples down from the luma sample in the upper left area of the reference layer picture becomes the luma sample in the upper left area of the reference region.

According to the present embodiment, the reference layer offset information and the current layer offset information are expressed as luma sample units, but in another embodiment, the reference layer offset information and the current layer offset information may be expressed as chroma sample units.

For example, when the color format of the current layer picture and the reference layer picture is 4:2:0, only one chroma sample corresponds to one luma sample 2×2 block. Therefore, values of the vertical offset and the horizontal offset expressed as luma sample units and included in the reference layer offset information and the current layer offset information may be twice as large as values of the vertical offset and the horizontal offset expressed as chroma sample units.

On the other hand, when the color format of the current layer picture and the reference layer picture is 4:4:4, a luma sample and a chroma sample correspond to each other. Therefore, all offsets of the reference layer offset information and the current layer offset information have same values in a luma sample unit and a chroma sample unit.

A method of determining the reference region and the expanded reference region from the reference layer size information, the reference layer offset information, the current layer size information, and the current layer offset information, the method being performed by the decoder 120 to be described below, will now be described.

The receiving and extracting unit 110 may obtain, from the bitstream, residual data to be used in reconstructing the current layer.

The residual data includes a difference value between a sample value of an image and a sample value of an original image, wherein the image is obtained by upsampling the original image of the current layer which was downsampled during the encoding procedure. The decoder 120 reconstructs the current layer by using the residual data and a prediction image of the current layer which is generated by upsampling the reference layer.

The decoder 120 upsamples the reference layer, based on information obtained by the receiving and extracting unit 110. Then, the decoder 120 predicts the current layer, based on the upsampled reference layer.

The decoder 120 may determine a size of the reference region from the reference layer size information and the reference layer offset information. For example, the decoder 120 may determine a height of the reference region by subtracting the reference layer top offset and the reference layer bottom offset from the height of the reference layer. The decoder 120 may determine a width of the reference region by subtracting the reference layer right offset and the reference layer left offset from the width of the reference layer.

The decoder 120 may determine the size of the expanded reference region from the current layer size information and the current layer offset information. For example, the decoder 120 may determine a height of the expanded reference region by subtracting the current layer top offset and the current layer bottom offset from the height of the current layer. The decoder 120 may determine a width of the expanded reference region by subtracting the current layer right offset and the current layer left offset from the width of the current layer.

When all offset values of the reference layer offset information are 0, the decoder 120 may determine an entire region of the reference layer as the reference region. Equally, when all offset values of the current layer offset information are 0, the decoder 120 may determine an entire region of the current layer as the expanded reference region.

The decoder 120 may determine a scale ratio indicating a ratio of the size of the reference area to the size of expanded reference area, based on the size of the reference area and the size of expanded reference area. The scale ratio indicates a ratio of the reference region to the expanded reference region. The scale ratio includes a horizontal scale ratio indicating a ratio of a width of the reference region to a width of the expanded reference region, and a vertical scale ratio indicating a ratio of a height of the reference region to a height of the expanded reference region. For example, when the vertical scale ratio and the horizontal scale ratio are both 1:2, and the number of luma samples of the reference region is 16×16, the number of luma samples of the expanded reference region may be 32×32.

The decoder 120 determines the scale ratio from the size of the reference region and the size of the expanded reference region. The decoder 120 may determine the horizontal scale ratio by comparing the width of the reference region with the width of the expanded reference region. In addition, the decoder 120 may determine the vertical scale ratio by comparing the height of the reference region with the height of the expanded reference region.

With reference to FIG. 4B, a method of determining the reference region, the expanded reference region, and the scale ratio, the method being performed by the decoder 120, will now be described in detail.

FIG. 4B illustrates a current layer picture 410 and a reference layer picture 430. An expanded reference region 420 is defined in the current layer picture 410, and a reference region 440 is defined in the reference layer picture 430.

A width 422a and height 422b of the expanded reference region 420 may be determined based on a width 412a and height 412b of the current layer picture 410 and current layer offset information 414a, 414b, 414c, and 414d.

The current layer offset information 414a, 414b, 414c, and 414d may include a current layer left offset 414a, a current layer top offset 414b, a current layer right offset 414c, and a current layer bottom offset 414d.

The width 422a of the expanded reference region 420 may be determined by subtracting the current layer left offset 414a and the current layer right offset 414c from the width 412a of the current layer picture 410.

The height 422b of the expanded reference region 420 may be determined by subtracting the current layer top offset 414b and the current layer bottom offset 414d from the height 412b of the current layer picture 410.

A width 442a and height 442b of the reference region 440 may be determined based on a width 432a and height 432b of the reference layer picture 430, and reference layer offset information 434a, 434b, 434c, and 434d.

The reference layer offset information 434a, 434b, 434c, and 434d may include a reference layer left offset 434a, a reference layer top offset 434b, a reference layer right offset 434c, and a reference layer bottom offset 434d.

The width 422a of the expanded reference region 420 may be determined by subtracting the current layer left offset 414a and the current layer right offset 414c from the width 412a of the current layer picture 410.

The height 442b of the reference region 440 may be determined by subtracting the reference layer top offset 434b and the reference layer bottom offset 434d from the height 432b of the reference layer picture 430.

The horizontal scale ratio may be determined by comparing the width 442a of the reference region 440 with the width 422a of the expanded reference region 420. In more detail, a value obtained by dividing the width 422a of the expanded reference region 420 by the width 442a of the reference region 440 may be determined as the horizontal scale ratio.

The vertical scale ratio may be determined by comparing the height 442b of the reference region 440 with the height 422b of the expanded reference region 420. In more detail, a value obtained by dividing the height 422b of the expanded reference region 420 by the height 442b of the reference region 440 may be determined as the vertical scale ratio.

When the horizontal scale ratio and the vertical scale ratio are determined, the decoder 120 may determine a prediction picture of the expanded reference region by upsampling the reference region, based on reference region offset information, current region offset information, the horizontal scale ratio, and the vertical scale ratio. In the present specification, upsampling of the reference layer is interpreted to be equal to upsampling of the reference region.

The decoder 120 may adjust a phase of a luma sample and a chroma sample included in a prediction picture of the current layer. The decoder 120 may also adjust a phase of a luma sample and a chroma sample included in the prediction picture of the expanded reference region which is determined during the upsampling process based on the reference region offset information, the current region offset information, the horizontal scale ratio, and the vertical scale ratio.

The decoder 120 determines sample values of samples of the expanded reference region, based on sample values of the reference region. During an interpolation process, a phase of the samples of the expanded reference region, a filter coefficient of an interpolation filter set, and the sample values of the reference region are used.

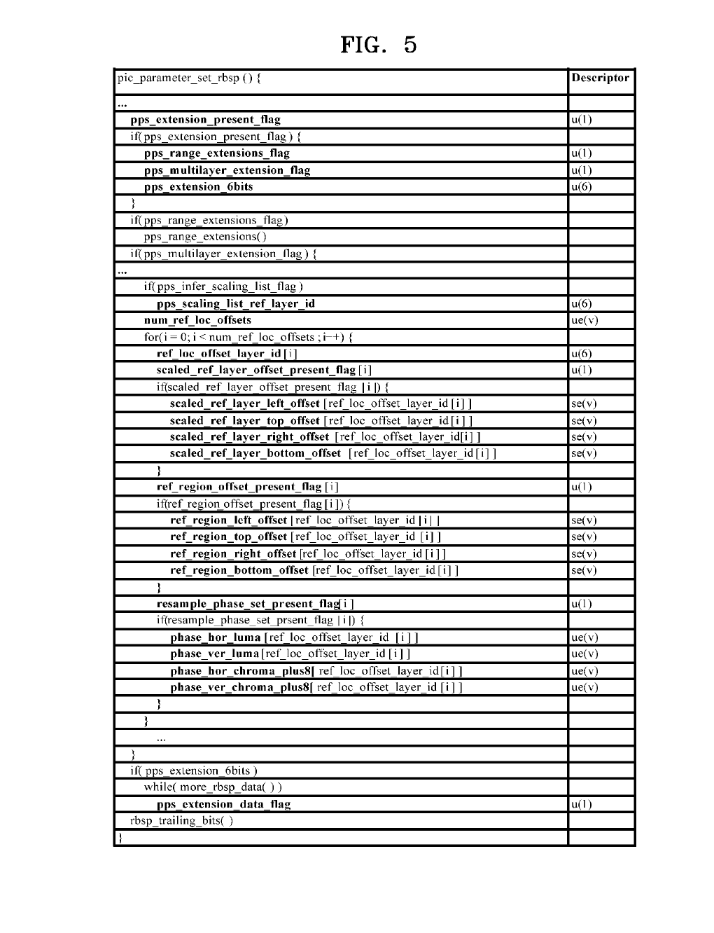

With reference to FIG. 5, a method of determining the phase of the samples included in the expanded reference region is described in detail.

The decoder 120 may determine prediction values of a region of the current layer which is not included in the expanded reference region. The prediction values may be determined based on the sample values of the samples included in the prediction picture of the expanded reference region. The decoder 120 may determine the prediction values of the region of the current layer which is not included in the expanded reference region, by using a padding method, a cropping method, an upsampling method, a downsampling method, or the like, based on the sample values of the samples of the expanded reference region. Accordingly, a prediction picture of the current layer may be determined by using the prediction picture of the expanded reference region and the prediction values of the region that is not included in the expanded reference region.

The decoder 120 may reconstruct the current layer by using the prediction picture and the residual data obtained by the receiving and extracting unit 110.

An embodiment of the receiving and extracting unit 110 and the decoder 120 will be described in detail with reference to FIG. 5.

FIG. 1B illustrates a flowchart of a scalable video encoding method 10 performed by the scalable video decoding apparatus 100, according to an embodiment.

In operation 11, upsampling phase set information indicating whether a phase of samples included in a current layer is adjusted while sample values of the samples included in the current layer are determined based on sample values of samples of a reference layer is obtained from a bitstream.

In operation 12, when the upsampling phase set information indicates that the phase is adjusted, a luma vertical phase difference, a luma horizontal phase difference, a chroma vertical phase difference, and a chroma horizontal phase difference are obtained from the bitstream.

As in operation 11 or operation 12, reference layer size information indicating a height and width of the reference layer, reference layer offset information for defining a reference region of the reference layer which is used in inter-layer prediction, current layer size information indicating a height and width of the current layer, and current layer offset information for defining an expanded reference region of the current layer which corresponds to the reference region may be obtained from the bitstream. In addition, residual data including a difference value between the sample values included in the current layer and sample values included in a reference picture of the current layer may be obtained from the bitstream.

Operation 11 and operation 12 are performed by the receiving and extracting unit 110.

In operation 13, a prediction picture of the current layer is determined by upsampling the reference layer based on the luma vertical phase difference, the luma horizontal phase difference, the chroma vertical phase difference, and the chroma horizontal phase difference.

Then, as in operation 13, a size of the reference region may be determined from the reference layer size information and the reference layer offset information, a size of the expanded reference region may be determined from the current layer size information and the current layer offset information, and a scale ratio indicating a ratio of the size of the reference region to the size of the expanded reference region may be determined based on the size of the reference region and the size of the expanded reference region. The determined reference layer offset information, the current layer offset information, and the scale ratio may be used in upsampling the reference layer.

After operation 13, the current picture may be reconstructed by using the residual data and the prediction picture.

Operation 13 is performed by the decoder 120.

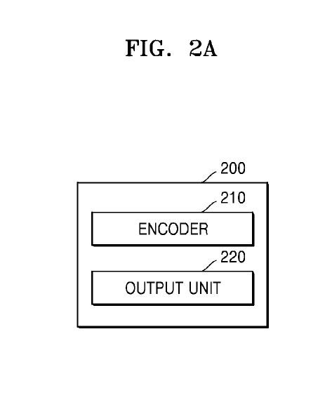

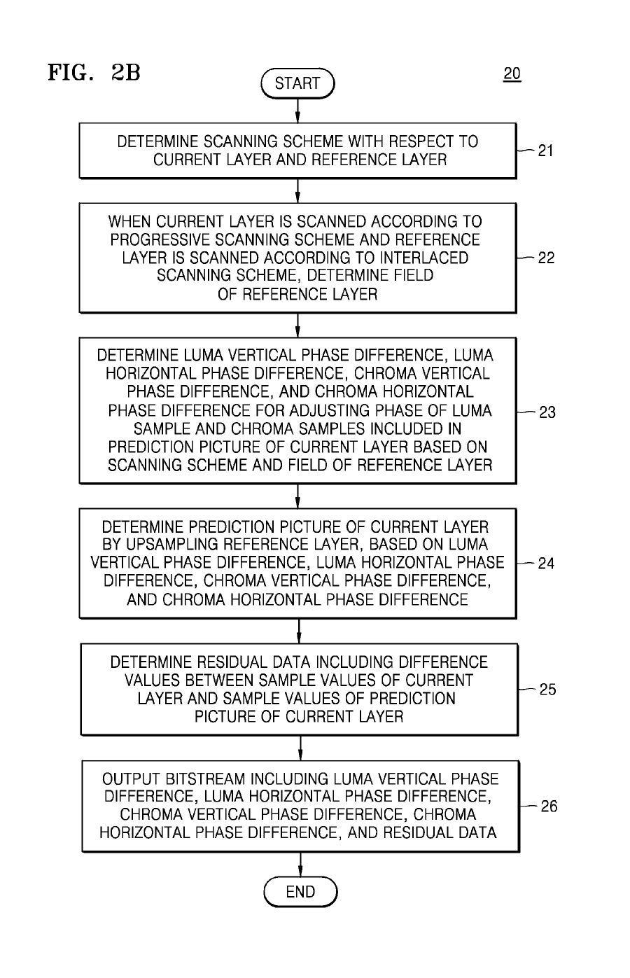

FIG. 2A illustrates a block diagram of the scalable video encoding apparatus 200, according to an embodiment.

The scalable video encoding apparatus 200 may include an encoder 210 and an output unit 220. Referring to FIG. 2A, the encoder 210 and the output unit 220 are illustrated as separate elements, but in another embodiment, the encoder 210 and the output unit 220 may be combined and thus may be implemented as one element.

Referring to FIG. 2A, the encoder 210 and the output unit 220 are illustrated as elements in one apparatus, but apparatuses respectively performing functions of the encoder 210 and the output unit 220 may not be physically adjacent to each other. Therefore, in another embodiment, the encoder 210 and the output unit 220 may be dispersed.

The encoder 210 and the output unit 220 of FIG. 2A may be implemented by one processor in an embodiment. In another embodiment, they may be implemented by a plurality of processors.

The scalable video encoding apparatus 200 may include a storage (not shown) to store data generated by the encoder 210 and the output unit 220. In addition, the encoder 210 and the output unit 220 may extract stored data from the storage (not shown) and may use the data.

The scalable video encoding apparatus 200 of FIG. 2A is not limited to a physical apparatus. For example, some function among functions of the scalable video encoding apparatus 200 may not be implemented as hardware but may be implemented as software.

The encoder 210 encodes an original image input to the scalable video encoding apparatus 200. In more detail, the original image is input to the current layer, and an image obtained by downsampling the original image is input to the reference layer. Then, the reference layer and the current layer are encoded.

When a phase of a chroma sample with respect to a luma sample is adjusted while the original image is downsampled, the encoder 210 determines a vertical luma-chroma phase difference and a horizontal luma-chroma phase difference, based on a phase difference of the adjusted chroma sample. According to the present embodiment, in general, the vertical luma-chroma phase difference and the horizontal luma-chroma phase difference are determined to be 1 and 0, respectively. However, the vertical luma-chroma phase difference and the horizontal luma-chroma phase difference may be determined as different values in another embodiment.

The encoder 210 may adjust a phase of samples included in a prediction picture of the current layer, based on an alignment scheme used in downsampling the original image.

The encoder 210 may adjust the phase of the samples included in the prediction picture of the current layer, based on a scanning scheme. When an interlaced scanning scheme is used and a downsampled image is an even field, the encoder 210 may adjust the phase of the samples included in the prediction picture of the current layer.

The encoder 210 may determine a luma vertical phase difference, a luma horizontal phase difference, a chroma vertical phase difference, and a chroma horizontal phase difference by using Equation 1 and Equation 2 described above with reference to FIG. 1A.

The encoder 210 may determine a reference region of the reference layer which is to be used in inter-layer prediction with respect to the current layer, may upsample the reference region, and thus may generate the expanded reference region.

The encoder 210 may encode the reference layer independently from the current layer.

In addition, the encoder 210 may encode the reference layer by using a method of encoding a single layer picture based on a tree structure.

The encoder 210 may encode a current layer picture by using the reference region. In another embodiment, the encoder 210 may encode the current layer independently from the reference layer, without using the reference layer.

The inter-layer prediction by the encoder 210 will be described in detail with reference to FIGS. 6A and 6B. The encoding based on the tree structure will be described in detail with reference to FIGS. 8 through 17.

The encoder 210 may determine reference layer size information and reference layer offset information from the reference layer and the reference region.

The encoder 210 may determine current layer size information and current layer offset information from the current layer and the expanded reference region.

The encoder 210 may upsample the reference layer, based on the vertical luma-chroma phase difference, the horizontal luma-chroma phase difference, alignment scheme specifying information, scanning scheme specifying information, and information regarding the reference region and the expanded reference region. The encoder 210 may generate residual data by comparing the prediction picture of the current layer with the current layer, wherein the prediction picture is generated by upsampling the reference layer.

The output unit 220 transmits a bitstream including the reference layer size information, the reference layer offset information, the current layer size information, the current layer offset information, the luma vertical phase difference, the luma horizontal phase difference, the chroma vertical phase difference, the chroma horizontal phase difference, and the residual data which are determined by the encoder 210.

FIG. 2B illustrates a flowchart of a scalable video encoding method 20 performed by the scalable video encoding apparatus 200, according to an embodiment.

In operation 21, a scanning scheme with respect to a current layer and a reference layer is determined.

In operation 22, when the current layer is scanned according to a progressive scanning scheme and the reference layer is scanned according to an interlaced scanning scheme, a field of the reference layer is determined.

In operation 23, a horizontal phase difference and a vertical phase difference for adjusting a phase of a luma sample and chroma samples included in a prediction picture of the current layer based on the scanning scheme and the field of the reference layer are determined.

In operation 24, the prediction picture of the current layer is determined by upsampling the reference layer, based on the horizontal phase difference and the vertical phase difference.

In operation 25, residual data including difference values between sample values of the current layer and sample values of the prediction picture of the current layer is determined.

Operation 21 through operation 25 may be performed by the encoder 210.

In operation 26, a bitstream including the horizontal phase difference, the vertical phase difference, and the residual data is output.

Operation 26 is performed by the output unit 220.

FIG. 5 illustrates syntax for describing an encoding information obtaining procedure, according to an embodiment. With descriptions regarding FIG. 5, equations for describing an upsampling method using encoding information are also provided.

FIG. 5 illustrates upsampling parameters included in a picture parameter set. The picture parameter set includes information that is commonly applied to slice segments included in one picture. FIG. 5 illustrates syntax with respect to the upsampling parameters.

num_ref_loc_offsets

for( i = 0; i < num_ref_loc_offsets; i++) {

ref_loc_offset_layer_id[ i ]
scaled_ref_layer_offset_present_flag[ i ]
if(scaled_ref_layer_offset_present_flag[ i ]) {

scaled_ref_layer_left_offset[ ref_loc_offset_layer_id[ i ] ]

scaled_ref_layer_top_offset[ ref_loc_offset_layer_id[ i ] ]
scaled_ref_layer_right_offset[ ref_loc_offset_layer_id[ i ] ]
scaled_ref_layer_bottom_offset[ ref_loc_offset_layer_id[ i ] ]

}
ref_region_offset_present_flag[ i ]
if(ref_region_offset_present_flag[ i ]) {

ref_region_left_offset[ ref_loc_offset_layer_id[ i ] ]
ref_region_top_offset[ ref_loc_offset_layer_id[ i ] ]

ref_region_right_offset[ref_loc_offset_layer_id[ i ] ]

ref_region_bottom_offset[ref_loc_offset_layer_id[ i ] ]

}
resample_phase_set_present_flag[ i ]
if(resample_phase_set_prsent_flag[ i ]) {

phase_hor_luma[ ref_loc_offset_layer_id[ i ] ]
phase_ver_luma[ ref_loc_offset_layer_id[ i ] ]
phase_hor_chroma_plus8[ ref_loc_offset_layer_id[ i ] ]
phase_ver_chroma_plus8[ ref_loc_offset_layer_id[ i ] ]

}

}

num_ref_loc_offsets refers to a maximal value of the number of upsampling information sets. In a scalable encoding scheme, an image may be encoded to two or more layers. The upsampling information set includes reference layer offset information, current layer offset information, and phase information which are required in an up-sampling process. When n layers are present, the upsampling process may occur n−1 times, thus, a maximal value of num_ref_loc_offsets is n−1. Therefore, when the image is encoded to n layers, the scalable video decoding apparatus 100 determines the number of upsampling information set by parsing num_ref_loc_offsets.

When num_ref_loc_offsets is obtained and i is 0, 1, . . . , (num_ref_loc_offsets−1), the scalable video decoding apparatus 100 obtains reference layer offset information, current layer offset information, and phase information with respect to a layer corresponding to i.

ref_loc_offset_layer_id[i] indicates an identification number of iₜₕ upsampling information set. For example, when the image is encoded to 4 layers from a first layer that is a lowermost layer to a fourth layer that is an uppermost layer, num_ref_loc_offsets may indicate 3, ref_loc_offset_layer_id [0] may indicate an upsampling information set between the first layer and a second layer, and ref_loc_offset_layer_id [2] may indicate an upsampling information set between a third layer and the fourth layer.

The scalable video decoding apparatus 100 may obtain current layer offset information from a bitstream. Then, the scalable video decoding apparatus 100 may determine an expanded reference region of a current layer from the current layer offset information. Hereinafter, syntax and equations related thereto will now be described.

scaled_ref_layer_offset_present_flag[i] indicates whether the current layer offset information is included in the iₜₕ upsampling information set. If scaled_ref_layer_offset_present_flag[i] indicates 1, the current layer offset information is included in the iₜₕ upsampling information set, and if scaled_ref_layer_offset_present_flag[i] indicates 0, the current layer offset information is not included in the iₜₕ upsampling information set. If scaled_ref_layer_offset_present_flag[i] is not present, a value of scaled_ref_layer_offset_present_flag[i] is regarded as 0.

When the scaled_ref_layer offset_present_flag [i] indicates 1, the scalable video decoding apparatus 100 may obtain, from the bitstream, scaled_ref_layer_left_offset[ref_loc_offset_layer_id[i]], scaled_ref_layer_top_offset[ref_loc_offset_layer_id[i]], scaled_ref_layer_right_offset[ref_loc_offset_layer_id[i]], and scaled_ref_layer_bottom_offset[ref_loc_offset_layer_id[i]].

scaled_ref_layer_left_offset[ref_loc_offset_layer_id[i]] indicates a current layer left offset corresponding to ref_loc_offset_layer_id[i]. If scaled_ref_layer_left_offset[ref_loc_offset_layer_id[i]] is not present in the bitstream, the scalable video decoding apparatus 100 determines scaled_ref_layer_left_offset[ref_loc_offset_layer_id[i]] as 0.

scaled_ref_layer_top_offset[ref_loc_offset_layer_id[i]] indicates a current layer top offset corresponding to ref_loc_offset_layer_id [i]. If scaled_ref_layer_top_offset[ref_loc_offset_layer_id [0]] is not present in the bitstream, the scalable video decoding apparatus 100 determines scaled_ref_layer_top_offset[ref_loc_offset_layer_id [0]] as 0.

scaled_ref_layer_right_offset[ref_loc_offset_layer_id[i]] indicates a current layer_right offset corresponding to ref_loc_offset_layer_id [i]. If scaled_ref_layer_right_offset[ref_loc_offset_layer_id[i]] is not present in the bitstream, the scalable video decoding apparatus 100 determines scaled_ref_layer_right_offset[ref_loc_offset_layer_id[i]]] as 0.

scaled_ref_layer_bottom_offset[ref_loc_offset_layer_id[i]] indicates a current layer bottom offset corresponding to ref_loc_offset_layer_id [i]. If scaled_ref_layer_bottom_offset[ref_loc_offset_layer_id[i]] is not present in the bitstream, the scalable video decoding apparatus 100 determines scaled_ref_layer_bottom_offset[ref_loc_offset_layer_id[i]] as 0.

scaled_ref_layer_left_offset[ref_loc_offset_layer_id[i]], scaled_ref_layer_top_offset[ref_loc_offset_layer_id[i]], scaled_ref_layer_right_offset[ref_loc_offset_layer_id[i]], and scaled_ref_layer_bottom_offset[ref_loc_offset_layer_id[i]] which are described above may be values each expressed as a luma sample unit. When the offsets are each expressed as a chroma sample unit, the scalable video decoding apparatus 100 may convert the offsets to a luma sample unit according to a color format.

The scalable video decoding apparatus 100 may determine a height and width of a current layer picture by using the obtained scaled_ref_layer_left_offset[ref_loc_offset_layer_id[i]], scaled_ref_layer_top_offset[ref_loc_offset_layer_id[i]], scaled_ref_layer_right_offset[ref_loc_offset_layer_id[i]] and scaled_ref_layer_bottom_offset[ref_loc_offset_layer_id[i]]. A height and width of the expanded reference region may be determined according to Equation 3 and Equation 4. By using Equation 3 and Equation 4, the height and width of the expanded reference region may be determined with respect to a luma sample.

ScaledRefLayerRegionWidthInSamplesY=PicWidthInSamplesCurrY−ScaledRefLayerRegionLeftOffset−ScaledRefLayerRegionRightOffset [Equation 3]

ScaledRefLayerRegionHeightInSamplesY=PicHeightInSamplesCurrY−ScaledRefLayerRegionTopOffset−ScaledRefLayerRegionBottomOffset [Equation 4]

In Equation 3 and Equation 4, ScaledRefLayerRegionWidthInSamplesY indicates the width of the expanded reference region, and ScaledRefLayerRegionHeightInSamplesY indicates the height of the expanded reference region. PicWidthInSamplesCurrY indicates the width of the current layer, and PicHeightInSamplesCurrY indicates the height of the current layer.

ScaledRefLayerRegionLeftOffset, ScaledRefLayerRegionRightOffset, ScaledRefLayerRegionTopOffset, and ScaledRefLayerRegionBottomOffset indicate a current layer left offset, a current layer top offset, a current layer right offset, and a current layer bottom offset that the scalable video decoding apparatus 100 obtains from the bitstream.

According to Equation 3, ScaledRefLayerRegionWidthInSamplesY is determined by subtracting ScaledRefLayerRegionLeftOffset and ScaledRefLayerRegionRightOffset from PicWidthInSamplesCurrY.

According to Equation 4, ScaledRefLayerRegionHeightInSamplesY is determined by subtracting ScaledRefLayerRegionTopOffset and ScaledRefLayerRegionBottomOffset from PicHeightInSamplesCurrY.

The scalable video decoding apparatus 100 may obtain reference layer offset information from the bitstream. Then, the scalable video decoding apparatus 100 may determine a reference region of a reference layer from the reference layer offset information.

Hereinafter, syntax and equations related thereto will now be described. ref_region_offset_present_flag[i] indicates whether the reference layer offset information is included in the iₜₕ upsampling information set. If ref_region_offset_present_flag[i] indicates 1, the reference layer offset information is included in the iₜₕ upsampling information set, and if ref_region_offset_present_flag[i] indicates 0, the reference layer offset information is not included in the iₜₕ upsampling information set. If ref_region_offset_present_flag[i] is not present, a value of ref_region_offset_present_flag[i] is regarded as 0.

When ref_region_offset_present_flag[i] indicates 1, the scalable video decoding apparatus 100 may obtain ref_region_left_offset[ref_loc_offset_layer_id[i]], ref_region_top_offset[ref_loc_offset_layer_id[i]], ref_region_right_offset[ref_loc_offset_layer_id[i]], and ref_region_bottom_offset[ref_loc_offset_layer_id[i]] from the bitstream.

ref_region_left_offset[ref_loc_offset_layer_id[i]] indicates a reference layer left offset corresponding to ref_loc_offset_layer_id[i]. If ref_region_left_offset[ref_loc_offset_layer_id[i]] is not present in the bitstream, the scalable video decoding apparatus 100 determines ref_region_left_offset[ref_loc_offset_layer_id[i]] as 0.

ref_region_top_offset[ref_loc_offset_layer_id[i]] indicates a reference layer top offset corresponding to ref_loc_offset_layer_id [i]. If ref_region_top_offset[ref_loc_offset_layer_id [0]] is not present in the bitstream, the scalable video decoding apparatus 100 determines ref_region_top_offset[ref_loc_offset_layer_id [0]] as 0.

ref_region_right_offset[ref_loc_offset_layer_id[i]] indicates a reference layer_right offset corresponding to ref_loc_offset_layer_id [i]. If ref_region_right_offset[ref_loc_offset_layer_id[i]] is not present in the bitstream, the scalable video decoding apparatus 100 determines ref_region_right_offset[ref_loc_offset_layer_id[i]]] as 0.

ref_region_bottom_offset[ref_loc_offset_layer_id[i]] indicates a reference layer bottom offset corresponding to ref_loc_offset_layer_id [i]. If ref_region_bottom_offset[ref_loc_offset_layer_id[i]] is not present in the bitstream, the scalable video decoding apparatus 100 determines ref_region_bottom_offset[ref_loc_offset_layer_id[i]] as 0.

ref_region_left_offset[ref_loc_offset_layer_id[i]], ref_region_top_offset[ref_loc_offset_layer_id[i]], ref_region_right_offset[ref_loc_offset_layer_id[i]], and ref_region_bottom_offset[ref_loc_offset_layer_id[i]] which are described above may be values each expressed as a luma sample unit. When the offsets are each expressed as a chroma sample unit, the scalable video decoding apparatus 100 may convert the offsets to a luma sample unit according to a color format.

The scalable video decoding apparatus 100 may determine a height and width of a reference layer picture by using the obtained ref_region_left_offset[ref_loc_offset_layer_id[i]], ref_region_top_offset[ref_loc_offset_layer_id[i]], ref_region_right_offset[ref_loc_offset_layer_id[i]] and ref_region_bottom_offset[ref_loc_offset_layer_id[i]].

The scalable video decoding apparatus 100 may determine a height and width of a reference region by using the obtained ref_layer_left_offset[ref_layer_id[i]], ref_layer_top_offset[ref_layer_id[i]], ref_layer_right_offset[ref_layer_id[i]] and ref_layer bottom_offset[ref_layer_id[i]]. The height and width of the reference region may be determined according to Equation 5 and Equation 6. By using Equation 5 and Equation 6, the height and width of the reference region may be determined with respect to a luma sample.

RefLayerRegionWidthInSamplesY=PicWidthInSamplesRefLayerY−RefLayerRegionLeftOffset−RefLayerRegionRightOffset [Equation 5]

RefLayerRegionHeightInSamplesY=PicHeightInSamplesRefLayerY−RefLayerRegionTopOffset−RefLayerRegionBottomOffset [Equation 6]

In Equation 5 and Equation 6, RefLayerRegionWidthInSamplesY indicates the width of the reference region, and RefLayerRegionHeightInSamplesY indicates the height of the reference region. PicWidthInSamplesRefLayerY indicates a width of the reference layer, and PicHeightInSamplesRefLayerY indicates a height of the reference layer.

RefLayerRegionLeftOffset, RefLayerRegionRightOffset, RefLayerRegionTopOffset, and RefLayerRegionBottomOffset mean a reference layer left offset, a reference layer top offset, a reference layer right offset, and a reference layer bottom offset that the scalable video decoding apparatus 100 obtains from the bitstream.

According to Equation 5, RefLayerRegionWidthInSamplesY is determined by subtracting RefLayerRegionLeftOffset and RefLayerRegionRightOffset from PicWidthInSamplesRefLayerY.

According to Equation 6, RefLayerRegionHeightInSamplesY is determined by subtracting RefLayerRegionTopOffset and RefLayerRegionBottomOffset from PicHeightInSamplesRefLayerY.

The scalable video decoding apparatus 100 may determine a horizontal scale ratio and a vertical scale ratio by using the height and width of the reference region and the height and width of the expanded reference region. The horizontal scale ratio and the vertical scale ratio may be determined according to Equation 7 and Equation 8. By using Equation 7 and Equation 8, the horizontal scale ratio and the vertical scale ratio are determined with respect to a luma sample.

SpatialScaleFactorHorY=((RefLayerRegionWidthInSamplesY<<16)+(ScaledRefRegionWidthInSamplesY>>1))/ScaledRefRegionWidthInSamplesY [Equation 7]

SpatialScaleFactorVerY=((RefLayerRegionHeightInSamplesY<<16)+(ScaledRefRegionHeightInSamplesY>>1))/ScaledRefRegionHeightInSamplesY [Equation 8]

In Equation 7 and Equation 8, SpatialScaleFactorHorY and SpatialScaleFactorVerY indicate the horizontal scale ratio and the vertical scale ratio, respectively, with respect to the luma sample.

According to Equation 7, SpatialScaleFactorHorY is equal to a value obtained by dividing another value by ScaledRefRegionWidthInSamplesY, the other value being obtained by shifting RefLayerRegionWidthInSamplesY to the right by 16 pixels.

In order to match a sample included in a prediction picture of the current layer with a coordinates plane of the reference layer, the width of the reference layer is divided by the width of the current layer. Then, in order to allow the horizontal scale ratio to be always greater than 1, RefLayerRegionWidthInSamplesY is multiplied by 2̂16 that is a maximal value of a ratio of the expanded reference region to the reference region.

According to Equation 7, in order to round off a result value of (RefLayerRegionWidthInSamplesY<<16)/ScaledRefRegionWidthInSamplesY, ScaledRefRegionWidthInSamplesY>>1 is added to RefLayerRegionWidthInSamplesY<<16.

According to Equation 8, SpatialScaleFactorVerY is equal to a value obtained by dividing another value by ScaledRefRegionHeightInSamplesY, the other value being obtained by shifting RefLayerRegionHeightInSamplesY to the right by 16 pixels. In order to match the sample included in the prediction picture of the current layer with the coordinates plane of the reference layer, the width of the reference layer is divided by the width of the current layer.

Thus, in order to allow the vertical scale ratio to be always greater than 1, RefLayerRegionHeightInSamplesY is multiplied by 2̂16 that is the maximal value of the ratio of the expanded reference region to the reference region.

According to Equation 8, in order to round off a result value of (RefLayerRegionHeightInSamplesY<<16)/ScaledRefRegionHeightInSamplesY, ScaledRefRegionHeightInSamplesY>>1 is added to RefLayerRegionHeightInSamplesY<<16.

Consequently, according to Equation 7 and Equation 8, a value obtained by dividing SpatialScaleFactorHorY by 2̂16 is an actual horizontal scale ratio, and a value obtained by dividing SpatialScaleFactorVerY by 2̂16 is an actual vertical scale ratio.

The scalable video decoding apparatus 100 may obtain phase information for adjusting a phase of samples during an upsampling process.

resample_phase_set_prsent_flag[i] indicates whether the phase information is included in the ith upsampling information set. If resample_phase_set_prsent_flag[i] indicates 1, the phase information is included in the ith upsampling information set, and if resample_phase_set_prsent_flag[i] indicates 0, the phase information is not included in the ith upsampling information set. If resample_phase_set_prsent_flag[i] is not present, a value of resample_phase_set_prsent_flag[i] is regarded as 0.

When resample_phase_set_prsent_flag[i] indicates 1, the scalable video decoding apparatus 100 may obtain phase_hor_luma[ref_loc_offset_layer_id[i]], phase_ver_luma[ref_loc_offset_layer_id[i]], phase_hor_chroma_plus8[ref_loc_offset_layer_id[i]], and phase_ver_chroma_plus8[ref_loc_offset_layer_id[i]] from the bitstream. phase_hor_luma[ref_loc_offset_layer_id[i]] indicates a horizontal phase difference of a luma component corresponding to ref_loc_offset_layer_id[i]. For example, when the horizontal phase difference of the luma component corresponding to ref_loc_offset_layer_id[i] is 1, phase_hor_luma[ref_loc_offset_layer_id[i]] indicates 1. If phase_hor_luma[ref_loc_offset_layer_id[i]] is not present in the bitstream, the scalable video decoding apparatus 100 determines phase_hor_luma[ref_loc_offset_layer_id[i]] as 0.

phase_ver_luma[ref_loc_offset_layer_id[i]] indicates a vertical phase difference of the luma component corresponding to ref_loc_offset_layer_id[i]. For example, when the vertical phase difference of the luma component corresponding to ref_loc_offset_layer_id[i] is 2, phase_ver_luma[ref_loc_offset_layer_id[i]] indicates 2. If phase_ver_luma[ref_loc_offset_layer_id[i]] is not present in the bitstream, the scalable video decoding apparatus 100 determines phase_ver_luma[ref_loc_offset_layer_id[i]] as 0.

phase_hor_chroma_plus8 [ref_loc_offset_layer_id[i]] indicates a horizontal phase difference of the luma component corresponding to ref_loc_offset_layer_id[i]. For example, a horizontal phase difference of a chroma component corresponding to ref_loc_offset_layer_id[i] is 1, phase_hor_chroma_plus8 [ref_loc_offset_layer_id[i]] indicates 1. If phase_hor_chroma_plus8 [ref_loc_offset_layer_id[i]] is not present in the bitstream, the scalable video decoding apparatus 100 determines phase_hor_chroma_plus8[ref_loc_offset_layer_id[i]] as 0.

phase_ver_chroma_plus8 [ref_loc_offset_layer_id[i]] indicates a vertical phase difference of the luma component corresponding to ref_loc_offset_layer_id[i]. For example, when a vertical phase difference of the chroma component corresponding to ref_loc_offset_layer_id[i] is 1, phase_ver_chroma_plus8 [ref_loc_offset_layer_id[i]] indicates 1. If phase_ver_chroma_plus8 [ref_loc_offset_layer_id[i]] is not present in the bitstream, the scalable video decoding apparatus 100 determines phase_ver_chroma[ref_loc_offset_layer_id[i]] as 0.

phase_hor_luma[ref_loc_offset_layer_id[i]], phase_ver_luma[ref_loc_offset_layer_id[i]], phase_hor_chroma_plus8[ref_loc_offset_layer_id[i]], and phase_ver_chroma_plus8[ref_loc_offset_layer_id[i]] may be values that are preset in the encoding procedure by using Equation 1 and Equation 2.

The scalable video decoding apparatus 100 may upsample the reference region by using the reference layer offset information, the current layer offset information, the vertical scale ratio, the horizontal scale ratio, the vertical phase difference, and the horizontal phase difference. With reference to Equations 9 through 20, a method of upsampling the reference region will now be described.

In Equations 9 through 20, offset values used in an upsampling process are defined.

currOffsetX=ScaledRefLayerLeftOffset/((cIdx==0)?1:SubWidthCurrC) [Equation 9]

currOffsetY=ScaledRefLayerTopOffset/((cIdx==0)?1:SubHeightCurrC) [Equation 10]

refOffsetX=(RefLayerRegionLeftOffset/((cIdx==0)?1:SubWidthRefLayerC))<<4 [Equation 11]

refOffsetY=(RefLayerRegionTopOffset/((cIdx==0)?1:SubHeightRefLayerC))<<4 [Equation 12]

currOffsetX indicates a horizontal offset of the current layer. With respect to the luma sample, currOffsetX has a same value as ScaledRefLayerLeftOffset that is the current layer left offset. currOffsetY indicates a vertical offset of the current layer. With respect to the luma sample, currOffsetY has a same value as ScaledRefLayerTopOffset that is the current layer top offset. During an upsampling procedure with respect to a chroma sample, currOffsetX has a same value as ScaledRefLayerLeftOffset/SubWidthCurrC that are current layer left offsets. currOffsetY indicates the vertical offset of the current layer. currOffsetY has a same value as ScaledRefLayerTopOffset/SubHeightCurrC that are current layer top offsets.

reOffsetX indicates a horizontal offset of the reference layer. With respect to the luma sample, reOffsetX has a value obtained by performing shifting calculation on RefLayerRegionLeftOffset that is the reference layer left offset to the right by 4 pixels. refOffsetY indicates a vertical offset of the reference layer. With respect to the luma sample, refOffsetY has a value obtained by performing shifting calculation on RefLayerRegionTopOffset that is the reference layer top offset to the right by 4 pixels. With respect to the chroma sample, refOffsetX has a value obtained by performing shifting calculation on RefLayerRegionLeftOffset/SubWidthRefLayerC that are the reference layer left offsets to the right by 4 pixels. refOffsetY indicates the vertical offset of the reference layer. With respect to the chroma sample, refOffsetX has a value obtained by performing shifting calculation on RefLayerRegionTopOffset/SubHeightRefLayerC that are the reference layer top offsets to the right by 4.

SubWidthCurrC, SubHeightCurrC, SubWidthRefLayerC, and SubHeightRefLayerC are values used in the upsampling procedure with respect to the chroma sample, and may have a value of 1 or 2 according to a color format. For example, when a color format of the reference layer is all 4:2:0, SubWidthRefLayerC and SubHeightRefLayerC are each 2. When the color format of the reference layer is all 4:2:2, SubWidthRefLayerC is 2 and SubHeightRefLayerC is 1. When the color format of the reference layer is all 4:4:4, SubWidthRefLayerC and SubHeightRefLayerC are each 1. Equally, when a color format of the current layer is all 4:2:0, SubWidthCurrC and SubHeightCurrC are each 2. When the color format of the current layer is all 4:2:2, SubWidthCurrC is 2 and SubHeightCurrC is 1. When the color format of the current layer is all 4:4:4, SubWidthCurrC and SubHeightCurrC are each 1.

In Equations 13 through 16, a phase difference and a scale ratio used in the upsampling process are defined.

phaseX=(cIdx==0)?PhaseHorY:PhaseHorC [Equation 13]

phaseY=(cIdx==0)?PhaseVerY:PhaseVerC [Equation 14]

scaleX=(cIdx==0)?SpatialScaleFactorHorY:SpatialScaleFactorHorC [Equation 15]

scaleY=(cIdx==0)?SpatialScaleFactorVerY:SpatialScaleFactorVerC [Equation 16]

phaseX indicates a horizontal phase difference. phaseX may have a value that varies according to a color component index. When the color component index indicates the luma sample, phaseX has a same value as PhaseHorY. When the color component index indicates the chroma sample, phaseX has a same value as PhaseHorC with respect to the chroma sample.

phaseY indicates a vertical phase difference. phaseY may have a value that varies according to the color component index. When the color component index indicates the luma sample, phaseY has a same value as PhaseVerY. When the color component index indicates the chroma sample, phaseY has a same value as PhaseVerC with respect to the chroma sample.

PhaseHorY and PhaseVerY are equal to phase_hor_luma[ref_loc_offset_layer_id[i]] and phase_ver_luma[ref_loc_offset_layer_id[i]].

PhaseHorC and PhaseVerC are equal to phase_hor_chroma_plus8 [ref_loc_offset_layer id[i]]−8 and phase_ver_chroma_plus8[ref_loc_offset_layer_id[i]]−8.

scaleX indicates a horizontal phase difference. scaleX may have a value that varies according to the color component index. When the color component index indicates the luma sample, scaleX has a same value as SpatialScaleFactorHorY. When the color component index indicates the chroma sample, scaleX has a same value as SpatialScaleFactorHorC with respect to the chroma sample.

scaleY indicates a vertical phase difference. scaleY may have a value that varies according to the color component index. When the color component index indicates the luma sample, scaleY has a same value as SpatialScaleFactorVerY. When the color component index indicates the chroma sample, scaleY has a same value as SpatialScaleFactorVerC with respect to the chroma sample.

In Equations 17 through 20, an upsampling method will now be described.

addX=−((scaleX*phaseX+8)>>4) [Equation 17]

addY=−((scaleY*phaseY+8)>>4) [Equation 18]

xRef16=(((xP−currOffsetX)*scaleX+addX+(1<<11))>>12)+refOffsetX [Equation 19]

yRef16=(((yP−currOffsetY)*scaleY+addY+(1<<11))>>12)+refOffsetY [Equation 20]

addX and addY indicate displacement of a sample location which occurs due to phase adjustment during an upsampling process according to a scale ratio. addX is determined as a negative value obtained by multiplying scaleX by phaseX. addY is determined as a negative value obtained by multiplying scaleY by phaseY. scaleX*phaseX and scaleY*phaseY are each rounded off to four decimal places and shifted to the right by 4 pixels. As a result, addX and addY are each determined.

xRef16 and yRef16 are values indicating to which location of a reference region a sample of an expanded reference region corresponds. xP and yP indicate a location of the sample of the expanded reference region. Therefore, by subtracting currOffsetX and currOffsetY from xP and yP, respectively, the location of the sample of the expanded reference region without a current layer offset is determined.

Then, scaleX and scaleY indicating a ratio of the expanded reference region to the reference region are multiplied by (xP−currOffsetX) and (yP−currOffsetY), respectively. Afterward, addX and addY indicating the displacement of the sample location are added thereto.

Next, (xP−currOffsetX)*scaleX+addX and (yP−currOffsetY)*scaleY+addY are each rounded off to twelve decimal places, and rounded values are each shifted to the right by 12 pixels.

Finally, refOffsetX and refOffsetY that each indicate an offset of the reference region are added to the result values, so that result values of xRef16 and yRef16 are determined.

scaleX and scaleY are generated by inserting 16 bit strings, each consisting of 0, to the right side of the ratio of the expanded reference region to the reference region, whereas, since only 12 right bit strings are removed from xRef16 and yRef16, a value that is 16 times greater than an area and width of the reference region is determined as a maximal value of xRef16 and yRef16. Therefore, values obtained by dividing xRef16 and yRef16 by 16 are matched with coordinates of the reference region. For example, a sample of the expanded reference region of which xRef16 is 96 is matched with a sample of the reference region of which x-coordinate is 6.

If xRef16 is 88, the sample of the expanded reference region is matched with a point of the reference region of which x-coordinate is 5.5. Therefore, an accuracy of an interpolation process that is performed is 1/16 of a distance between adjacent samples.

According to the values of xRef16 and yRef16, samples of the reference region are determined to interpolate the sample of the expanded reference region. Samples from among samples of the reference region, which are adjacent to xRef16 and yRef16, are used in interpolation. According to an embodiment, an 8-tap filter using 8 samples is mainly used in the interpolation. The interpolation is performed in at least one of a vertical direction and a horizontal direction according to the sample location.

The syntax described with reference to FIGS. 5A through 5D is an embodiment, and various embodiments of the present specification may be implemented by syntax having configuration different from that of the syntax of FIGS. 5A through 5D.

FIG. 6A illustrates a block diagram of a scalable video encoding apparatus 600, according to an embodiment.

The scalable video encoding apparatus 600 may include a downsampling unit 605, a reference layer encoder 610, an upsampling unit 650, a current layer encoder 660, and a multiplexer 690.

The downsampling unit 605 receives an input of a current layer picture 602. The downsampling unit 605 generates a reference layer picture 607 by downsampling the input current layer picture 602.

The reference layer encoder 610 receives an input of a reference layer picture 607. The reference layer encoder 610 encodes the reference layer picture 607. The reference layer encoder 610 may encode the reference layer picture 607 according to a single layer encoding scheme. The reference layer encoder 610 may reconstruct the reference layer picture 607 by encoding and then decoding the reference layer picture 607, and may store the reconstructed reference layer picture 607 in a storage (not shown). In addition, the reference layer encoder 610 may determine a reference region 651 from the reference layer picture 607.

The upsampling unit 650 receives an input of the reference region 651 from the reference layer encoder 610. The upsampling unit 650 determines an expanded reference region 652 by upsampling the reference region 651.

The current layer encoder 660 receives an input of a current layer picture 602 and the expanded reference region 652. The current layer encoder 660 may encode the current layer picture 602 according to the single layer encoding scheme. Also, the current layer encoder 660 may encode the current layer picture 602 by generating a prediction picture of the current layer picture 602 according to the expanded reference region 652.

The reference layer encoder 610 transmits a bitstream including encoding information of the reference layer picture 607 to the multiplexer 690. The current layer encoder 660 transmits a bitstream including encoding information of the current layer picture 602 to the multiplexer 690.

The multiplexer 690 generates a scalable bitstream 695 by combining the bitstreams transmitted from the reference layer encoder 610 and the current layer encoder 660.

The reference layer encoder 610 or the current layer encoder 660 may determine a vertical phase difference and a horizontal phase difference of a sample. The multiplexer 690 may output a scalable bitstream 695 including the determined vertical phase difference and horizontal phase difference.

The downsampling unit 605, the reference layer encoder 610, the upsampling unit 650, and the current layer encoder 660 correspond to the encoder 210 of FIG. 2A. The multiplexer 690 corresponds to the output unit 220 of FIG. 2A.

FIG. 6B illustrates a block diagram of the scalable video encoding apparatus 600, according to the embodiment. FIG. 6B particularly illustrates an encoding procedure by the reference layer encoder 610 and the current layer encoder 660.

The reference layer encoder 610 may encode the reference layer pictures 607 by splitting the reference layer pictures 607 according to a largest coding unit, a coding unit, a prediction unit, a transformation unit, or the like. An intra predictor 622 may predict the reference layer picture 607 by determining an optimal encoding mode according to an intra mode and a coded depth. A motion compensator 624 may predict the reference layer picture 607 by referring to a reference picture list stored in the storage. The reference picture list may include reference layer pictures input to the reference layer encoder 610. Residual data may be generated for each prediction unit according to intra prediction or inter prediction.

A transformer/quantizer 630 generates a quantized transformation coefficient by performing frequency transformation and quantization on the residual data. Then, an entropy encoder 632 entropy encodes the quantized transformation coefficient. The entropy encoded quantized transformation coefficient and a plurality of pieces of encoding information generated by an encoding procedure are transmitted to the multiplexer 690.

An inverse-transformer/inverse-quantizer 634 reconstructs the residual data by inverse quantizing and inverse transforming the quantized transformation coefficient. The intra predictor 622 or the motion compensator 624 reconstructs the reference layer picture 607 by using the residual data and the encoding information.

When the reference layer picture 607 is predicted according to an inter prediction mode, an encoding error of the reconstructed reference layer picture 607 may be compensated for by an in-loop filter 636. The in-loop filter 636 may include at least one of a deblocking filter and a Sample Adaptive Offset (SAO) filter.

The reconstructed reference layer picture 607 may be stored in a storage 638. In addition, the reconstructed reference layer picture 607 may be transmitted to the motion compensator 624 and may be used in prediction with respect to another reference layer picture.

The reference region 651 of the reference layer picture 607 stored in the storage 638 may be upsampled by the upsampling unit 650. The upsampling unit 650 may transmit an expanded reference region which is the upsampled reference region 651 to a storage 688 of the current layer encoder 660.

In addition, the motion compensator 624 may generate inter-layer motion prediction information 654 obtained by scaling motion prediction information according to a scale ratio of a current layer picture to a reference layer picture, the motion prediction information having been used in inter-prediction. The motion compensator 624 may transmit the inter-layer motion prediction information 654 to a motion compensator 674 of the current layer encoder 660.

According to the aforementioned scheme, an encoding operation with respect to reference layer pictures may be repeated.

The current layer encoder 660 may encode the current layer picture 602 by splitting the current layer picture 602 according to a largest coding unit, a coding unit, a prediction unit, a transformation unit, or the like. An intra predictor 672 may predict the current layer picture 602 by determining an optimal encoding mode according to an intra mode and a coded depth. A motion compensator 674 may predict the current layer picture 602 by referring to a reference picture list stored in the storage. In addition, for the inter-prediction, the motion compensator 674 may use the inter-layer motion prediction information 654 that is generated by the motion compensator 624 of the reference layer encoder 610. The reference picture list may include current layer pictures input to the current layer encoder 660, and the expanded reference region 652 upsampled by the upsampling unit 650. Residual data may be generated for each prediction unit according to the intra prediction or inter prediction.

A transformer/quantizer 680 generates a quantized transformation coefficient by performing frequency transformation and quantization on the residual data. Then, an entropy encoder 682 entropy encodes the quantized transformation coefficient. The entropy encoded quantized transformation coefficient and a plurality of pieces of encoding information generated by an encoding procedure are transmitted to the multiplexer 690.

An inverse-transformer/inverse-quantizer 684 reconstructs the residual data by inverse quantizing and inverse transforming the quantized transformation coefficient. The intra predictor 672 or the motion compensator 674 reconstructs the current layer picture 602 by using the residual data and the encoding information.

When the current layer picture 602 is predicted according to the inter prediction mode, an encoding error of the reconstructed current layer picture 602 may be compensated for by an in-loop filter 686. The in-loop filter 686 may include at least one of a deblocking filter and a Sample Adaptive Offset (SAO) filter.

The reconstructed current layer picture 602 may be stored in the storage 688. In addition, the reconstructed current layer picture 602 may be transmitted to the motion compensator 624 and may be used in prediction with respect to another reference layer picture.

According to the aforementioned scheme, an encoding operation with respect to current layer pictures may be repeated.

FIG. 7A illustrates a block diagram of a scalable video decoding apparatus 700, according to an embodiment.

The scalable video decoding apparatus 700 may include a demultiplexer 705, a reference layer decoder 710, an upsampling unit 750, and a current layer decoder 760.

The demultiplexer 705 receives an input of a scalable bitstream 702. Then, the demultiplexer 705 parses the scalable bitstream 702 and splits the scalable bitstream 702 into a bitstream regarding a current layer picture 797 and a bitstream regarding a reference layer picture 795. The bitstream regarding the current layer picture 797 is transmitted to the current layer decoder 760. The bitstream regarding the reference layer picture 795 is transmitted to the reference layer decoder 710.

The reference layer decoder 710 decodes the input bitstream regarding the reference layer picture 795. The reference layer decoder 710 may decode the reference layer picture 795 according to a single layer decoding scheme. The reference layer decoder 710 may store the decoded reference layer picture 795 in a storage (not shown). In addition, the reference layer decoder 710 may determine a reference region 751 from the decoded reference layer picture 795. The reference layer picture 795 may be output due to a decoding procedure by the reference layer decoder 710.

The upsampling unit 750 receives an input of a reference region 751 from the reference layer decoder 710. Then, the upsampling unit 750 upsamples the reference region 751 and determines an expanded reference region 752.

The current layer decoder 760 receives an input of the bitstream regarding the current layer picture 797 and the expanded reference region 752. The current layer decoder 760 may decode the current layer picture 797 according to the single layer decoding scheme. In addition, the current layer decoder 760 may generate a prediction picture of the current layer picture 797 according to the expanded reference region 752 and may decode the current layer picture 797.

The current layer picture 797 may be output via a decoding procedure by the current layer decoder 760.

The demultiplexer 705 may obtain a vertical phase difference and a horizontal phase difference from the scalable bitstream 702. The upsampling unit 750 may upsample the reference region 751, based on the vertical phase difference and the horizontal phase difference of a sample.

The demultiplexer 705 corresponds to the receiving and extracting unit 110 of FIG. 1A.

The reference layer decoder 710, the upsampling unit 750, and the current layer decoder 760 correspond to the decoder 120 of FIG. 1A.

FIG. 7B illustrates a block diagram of the scalable video decoding apparatus 700, according to the embodiment. FIG. 7B particularly illustrates a decoding procedure by the reference layer decoder 710 and the current layer decoder 760.

An entropy decoder 720 generates a quantized transformation coefficient by entropy decoding the bitstream regarding the reference layer picture 795. Then, an inverse-transformer/inverse-quantizer 722 reconstructs the residual data by inverse quantizing and inverse transforming the quantized transformation coefficient.

An intra predictor 732 may predict the reference layer picture 795 according to the residual data and the encoding information. A motion compensator 734 may predict the reference layer picture 795 by referring to the residual data and a reference picture list stored in a storage. The reference picture list includes reference layer pictures reconstructed by the reference layer decoder 710.

When the reference layer picture 795 is predicted according to an inter prediction mode, an encoding error of the reconstructed reference layer picture 795 may be compensated for by an in-loop filter 724. The in-loop filter 724 may include at least one of a deblocking filter and a Sample Adaptive Offset (SAO) filter.

The reconstructed reference layer picture 795 may be stored in a storage 738. The reconstructed reference layer picture 795 may be transmitted to the motion compensator 734 and may be used in prediction with respect to another reference layer picture.

The reference region 751 of the reference layer picture 795 stored in the storage 738 may be upsampled by the upsampling unit 750. The upsampling unit 750 may transmit an expanded reference region that is the upsampled reference region 751 to a storage 788 of the current layer decoder 760.

The in-loop filter 724 may generate inter-layer motion prediction information 754 obtained by scaling motion prediction information according to a scale ratio of a current layer picture to a reference layer picture, the motion prediction information having been used in inter-prediction. The motion compensator 734 may transmit the inter-layer motion prediction information 754 to a motion compensator 784 of the current layer decoder.

According to the aforementioned scheme, a decoding operation with respect to reference layer pictures may be repeated.

An entropy decoder 770 generates a quantized transformation coefficient by entropy decoding the bitstream regarding the current layer picture 797. Then, an inverse-transformer/inverse-quantizer 772 reconstructs the residual data by inverse quantizing and inverse transforming the quantized transformation coefficient.

An intra predictor 782 may predict the current layer picture 797 according to the residual data and the encoding information. A motion compensator 784 may predict the current layer picture 797 by referring to the residual data and a reference picture list stored in the storage 788. The motion compensator 784 may use the inter-layer motion prediction information 754 for the inter-prediction, the inter-layer motion prediction information 754 being generated by the motion compensator 734 of the reference layer decoder 710. The reference picture list includes current layer pictures reconstructed by the current layer decoder 760, and the expanded reference region 752 upsampled by the upsampling unit 750.

When the current layer picture 797 is predicted according to an inter prediction mode, an encoding error of the reconstructed current layer picture 797 may be compensated for by an in-loop filter 774. The in-loop filter 774 may include at least one of a deblocking filter and a Sample Adaptive Offset (SAO) filter.

The reconstructed current layer picture 797 may be stored in the storage 788. Then, the reconstructed current layer picture 797 may be transmitted to the motion compensator 784 and may be used in prediction with respect to another reference layer picture.

According to the aforementioned scheme, a decoding operation with respect to current layer pictures may be repeated.

Through the decoding operations, the reference layer picture 795 may be output from the reference layer decoder 710, and the current layer picture 797 may be output from the current layer decoder 760.

With reference to FIGS. 6 and 7, scalable video encoding/decoding apparatuses including only two layers are described. However, the encoding/decoding principles provided with reference to FIGS. 6 and 7 may also be applied to scalable video encoding/decoding apparatuses including three or more layers. For example, when an input image is encoded into a first layer, a second layer, and a third layer, an expanded reference region for inter-layer prediction and inter-layer motion prediction information may be generated during encoding procedures by a first layer encoder and a second layer encoder. Equally, an expanded reference region for inter-layer prediction and inter-layer motion prediction information may be generated during encoding procedures by the second layer encoder and a third layer encoder.

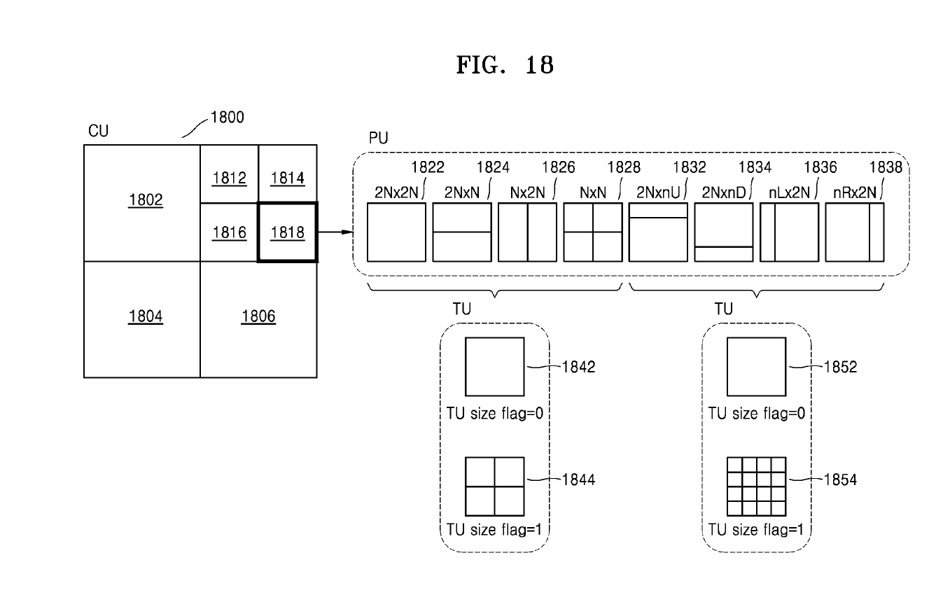

Encoding/decoding methods according to a tree structure performed in a block unit, which are described with reference to FIGS. 6 and 7, are described in detail with reference to FIGS. 8 and 18.

Therefore, for convenience of description, since a video encoding process and a video decoding process based on a coding unit according to a tree structure, which will be described with reference to FIGS. 8A through 18, are performed on a single-layer video, only inter prediction and motion compensation will be described. However, as described with reference to FIGS. 6A through 7B, inter-layer prediction and compensation between reference layer pictures and current layer pictures are performed to encode/decode a video stream.

Therefore, in order for the encoder 110 of the scalable video encoding apparatus 100 according to an embodiment to encode a multilayer video, based on coding units of a tree structure, the scalable video encoding apparatus 100 may include video encoding apparatuses 800 of FIG. 8A corresponding to the number of layers of the multilayer video so as to perform video encoding on each of single layer videos, and may control the video encoding apparatuses 800 to encode the single layer videos, respectively. Also, the scalable video encoding apparatus 100 may perform inter-view prediction by using encoding results with respect to discrete single views obtained by the video encoding apparatuses 800. Accordingly, the encoder 110 of the scalable video encoding apparatus 100 may generate a base layer video stream and a current layer video stream that include an encoding result of each layer.

Similarly, in order for a decoder of the scalable video decoding apparatus 200 to decode a multilayer video, based on coding units of a tree structure, the scalable video decoding apparatus 200 may include video decoding apparatuses 850 of FIG. 8B corresponding to the number of layers of a multilayer video so as to perform video decoding on each of layers of a received reference layer videostream and a received current layer videostream, and may control the video decoding apparatuses 850 to decode single layer videos, respectively. Then, the scalable video decoding apparatus 200 may perform inter-layer compensation by using decoding results with respect to discrete single layers obtained by the video decoding apparatuses 850. Accordingly, the scalable video decoding apparatus 200 may generate reference layer images and current layer images that are reconstructed for each of the layers.

FIG. 8A illustrates a block diagram of a video encoding apparatus based on coding units of a tree structure 800, according to various embodiments.

The video encoding apparatus involving video prediction based on coding units of the tree structure 800 includes an encoder 810 and an output unit 820. Hereinafter, for convenience of description, the video encoding apparatus involving video prediction based on coding units of the tree structure 800 is referred to as the ‘video encoding apparatus 800’.

The encoder 810 may split a current picture based on a largest coding unit that is a coding unit having a maximum size for a current picture of an image. If the current picture is larger than the largest coding unit, image data of the current picture may be split into the at least one largest coding unit. The largest coding unit according to an embodiment may be a data unit having a size of 32×32, 64×64, 128×128, 256×256, etc., wherein a shape of the data unit is a square having a width and length in squares of 2.

A coding unit according to an embodiment may be characterized by a maximum size and a depth. The depth denotes the number of times the coding unit is spatially split from the largest coding unit, and as the depth deepens, deeper coding units according to depths may be split from the largest coding unit to a smallest coding unit. A depth of the largest coding unit may be defined as an uppermost depth and a depth of the smallest coding unit may be defined as a lowermost depth. Since a size of a coding unit corresponding to each depth decreases as the depth of the largest coding unit deepens, a coding unit corresponding to an upper depth may include a plurality of coding units corresponding to lower depths.

As described above, the image data of the current picture is split into the largest coding units according to a maximum size of the coding unit, and each of the largest coding units may include deeper coding units that are split according to depths. Since the largest coding unit according to an embodiment is split according to depths, the image data of a spatial domain included in the largest coding unit may be hierarchically classified according to depths.

A maximum depth and a maximum size of a coding unit, which limit the total number of times a height and a width of the largest coding unit are hierarchically split, may be predetermined.

The encoder 810 encodes at least one split region obtained by splitting a region of the largest coding unit according to depths, and determines a depth to output a final encoding result according to the at least one split region. That is, the encoder 810 determines a coded depth by encoding the image data in the deeper coding units according to depths, according to the largest coding unit of the current picture, and selecting a depth having the least encoding error. The determined coded depth and image data according to largest coding units are output to the output unit 820.

The image data in the largest coding unit is encoded based on the deeper coding units corresponding to at least one depth equal to or below the maximum depth, and results of encoding the image data based on each of the deeper coding units are compared. A depth having the least encoding error may be selected after comparing encoding errors of the deeper coding units. At least one coded depth may be selected for each largest coding unit.

The size of the largest coding unit is split as a coding unit is hierarchically split according to depths, and as the number of coding units increases. Also, even if coding units correspond to the same depth in one largest coding unit, it is determined whether to split each of the coding units corresponding to the same depth to a lower depth by measuring an encoding error of the image data of the each coding unit, separately. Accordingly, even when image data is included in one largest coding unit, the encoding errors may differ according to regions in the one largest coding unit, and thus the coded depths may differ according to regions in the image data. Thus, one or more coded depths may be determined in one largest coding unit, and the image data of the largest coding unit may be divided according to coding units of at least one coded depth.

Accordingly, the encoder 810 according to an embodiment may determine coding units having a tree structure included in a current largest coding unit. The ‘coding units having a tree structure’ according to an embodiment include coding units corresponding to a depth determined to be the coded depth, from among all deeper coding units included in the current largest coding unit. A coding unit of a coded depth may be hierarchically determined according to depths in the same region of the largest coding unit, and may be independently determined in different regions. Equally, a coded depth in a current region may be independently determined from a coded depth in another region.

A maximum depth according to an embodiment is an index related to the number of splitting times from a largest coding unit to a smallest coding unit. A maximum depth according to an embodiment may denote the total number of splitting times from the largest coding unit to the smallest coding unit. For example, when a depth of the largest coding unit is 0, a depth of a coding unit, in which the largest coding unit is split once, may be set to 1, and a depth of a coding unit, in which the largest coding unit is split twice, may be set to 2. Here, if the smallest coding unit is a coding unit in which the largest coding unit is split four times, depth levels of depths 0, 1, 2, 3, and 4 exist, and thus the maximum depth may be set to 4.

Prediction encoding and transformation may be performed according to the largest coding unit. The prediction encoding and the transformation are also performed based on the deeper coding units according to a depth equal to or depths less than the maximum depth, according to the largest coding unit.

Since the number of deeper coding units increases whenever the largest coding unit is split according to depths, encoding, including the prediction encoding and the transformation, is performed on all of the deeper coding units generated as the depth deepens. Hereinafter, for convenience of description, the prediction encoding and the transformation will be described based on a coding unit of a current depth in at least one largest coding unit.

The video encoding apparatus 800 according to an embodiment may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 800 may select not only a coding unit for encoding the image data, but may also select a data unit different from the coding unit so as to perform the prediction encoding on the image data in the coding unit.

In order to perform prediction encoding in the largest coding unit, the prediction encoding may be performed based on a coding unit of a coded depth, i.e., based on the coding unit that is no longer split. Hereinafter, the coding unit that is no longer split and becomes a basis unit for prediction encoding will now be referred to as a ‘prediction unit’. A partition obtained by splitting the prediction unit may include a prediction unit and a data unit obtained by splitting at least one selected from a height and a width of the prediction unit. A partition is a data unit where a prediction unit of a coding unit is split, and a prediction unit may be a partition having the same size as a coding unit.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition type may selectively include symmetrical partitions obtained by symmetrically splitting a height or width of the prediction unit, partitions obtained by asymmetrically splitting the height or width of the prediction unit, such as 1:n or n:1, partitions obtained by geometrically splitting the prediction unit, or partitions having arbitrary shapes.

A prediction mode of the prediction unit may be at least one of an intra mode, an inter mode, and a skip mode. For example, the intra mode and the inter mode may be performed on the partition of 2N×2N, 2N×N, N×2N, or N×N. Also, the skip mode may be performed only on the partition of 2N×2N. The encoding may be independently performed on one prediction unit in a coding unit, thereby selecting a prediction mode having a least encoding error.

The video encoding apparatus 800 according to an embodiment may also perform the transformation on the image data in a coding unit based not only on the coding unit for encoding the image data, but also based on a data unit that is different from the coding unit. In order to perform the transformation in the coding unit, the transformation may be performed based on a data unit having a size smaller than or equal to the coding unit. For example, the transformation unit may include a data unit for an intra mode and a transformation unit for an inter mode.

The transformation unit in the coding unit may be recursively split into smaller sized regions in the similar manner as the coding unit according to the tree structure, thus, residual data of the coding unit may be divided according to the transformation unit having the tree structure according to a transformation depth.

A transformation depth indicating the number of splitting times to reach the transformation unit by splitting the height and width of the coding unit may also be set in the transformation unit. For example, in a current coding unit of 2N×2N, a transformation depth may be 0 when the size of a transformation unit is 2N×2N, may be 1 when the size of the transformation unit is N×N, and may be 2 when the size of the transformation unit is N/2×N/2. That is, with respect to the transformation unit, the transformation unit having the tree structure may be set according to the transformation depths.

Encoding information according to coded depths requires not only information about a coded depth but also requires information related to prediction and transformation. Accordingly, the encoder 810 may determine not only a coded depth generating a least encoding error but may also determine a partition type in which a prediction unit is split to partitions, a prediction mode according to prediction units, and a size of a transformation unit for transformation.

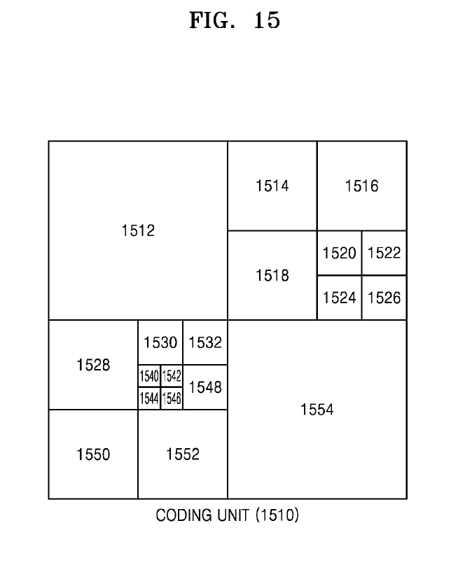

Coding units according to a tree structure in a largest coding unit and methods of determining a prediction unit/partition, and a transformation unit, according to embodiments, will be described in detail later with reference to FIGS. 15 through 24.

The encoder 810 may measure an encoding error of deeper coding units according to depths by using Rate-Distortion Optimization based on Lagrangian multipliers.

The output unit 820 outputs, in bitstreams, the image data of the largest coding unit, which is encoded based on the at least one coded depth determined by the encoder 810, and encoding mode information according to depths.

The encoded image data may correspond to a result obtained by encoding residual data of an image.

The encoding mode information according to depths may include coded depth information, partition type information of the prediction unit, prediction mode information, and the size information of the transformation unit.

Coded depth information may be defined by using split information according to depths, which specifies whether encoding is performed on coding units of a lower depth instead of a current depth. If the current depth of the current coding unit is a coded depth, the current coding unit is encoded by using the coding unit of the current depth, and thus split information of the current depth may be defined not to split the current coding unit to a lower depth. On the contrary, if the current depth of the current coding unit is not the coded depth, the encoding has to be performed on the coding unit of the lower depth, and thus the split information of the current depth may be defined to split the current coding unit to the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one largest coding unit, and at least one piece of encoding mode information has to be determined for a coding unit of a coded depth, at least one piece of encoding mode information may be determined for one largest coding unit. Also, a coded depth of data of the largest coding unit may vary according to locations since the data is hierarchically split according to depths, and thus a coded depth and encoding mode information may be set for the data.

Accordingly, the output unit 820 according to an embodiment may assign encoding information about a corresponding coded depth and an encoding mode to at least one of the coding unit, the prediction unit, and a minimum unit included in the largest coding unit.

The minimum unit according to an embodiment is a square data unit obtained by splitting the smallest coding unit constituting the lowermost coded depth by 4. Alternatively, the minimum unit according to an embodiment may be a maximum square data unit that may be included in all of the coding units, prediction units, partition units, and transformation units included in the largest coding unit.

For example, the encoding information output by the output unit 820 may be classified into encoding information according to deeper coding units, and encoding information according to prediction units. The encoding information according to the deeper coding units may include the information about the prediction mode and about the size of the partitions. The encoding information according to the prediction units may include information about an estimated direction during an inter mode, about a reference image index of the inter mode, about a motion vector, about a chroma component of an intra mode, and about an interpolation method during the intra mode.

Information about a maximum size of the coding unit defined according to pictures, slice segments, or GOPs, and information about a maximum depth may be inserted into a header of a bitstream, a sequence parameter set, or a picture parameter set.

Information about a maximum size of the transformation unit allowed with respect to a current video, and information about a minimum size of the transformation unit may also be output through a header of a bitstream, a sequence parameter set, or a picture parameter set. The output unit 820 may encode and output reference information, prediction information, and slice segment type information, which are related to prediction.

According to the simplest embodiment for the video encoding apparatus 800, the deeper coding unit may be a coding unit obtained by dividing a height or width of a coding unit of an upper depth, which is one layer above, by two. That is, when the size of the coding unit of the current depth is 2N×2N, the size of the coding unit of the lower depth is N×N. Also, a current coding unit having a size of 2N×2N may maximally include four lower-depth coding units having a size of N×N.

Accordingly, the video encoding apparatus 800 may form the coding units having the tree structure by determining coding units having an optimum shape and an optimum size for each largest coding unit, based on the size of the largest coding unit and the maximum depth determined considering characteristics of the current picture. Also, since encoding may be performed on each largest coding unit by using any one of various prediction modes and transformations, an optimal encoding mode may be determined by taking into account characteristics of the coding unit of various image sizes.

Thus, if an image having a high resolution or a large data amount is encoded in a conventional macroblock, the number of macroblocks per picture excessively increases. Accordingly, the number of pieces of compressed information generated for each macroblock increases, and thus it is difficult to transmit the compressed information and data compression efficiency decreases. However, by using the video encoding apparatus according to the embodiment, image compression efficiency may be increased since a coding unit is adjusted while considering characteristics of an image while increasing a maximum size of a coding unit while considering a size of the image.

The scalable video encoding apparatus 600 described above with reference to FIG. 6A may include the video encoding apparatuses 800 corresponding to the number of layers so as to encode single layer images in each of the layers of a multilayer video. For example, the reference layer encoder 610 may include one video encoding apparatus 800, and the current layer encoder 660 may include the video encoding apparatuses 800 corresponding to the number of current layers.

When the video encoding apparatus 800 encodes reference layer images, the encoder 810 may determine a prediction unit for inter-image prediction according to each of coding units of a tree structure in each largest coding unit, and may perform the inter-image prediction on each prediction unit.

When the video encoding apparatus 800 encodes the current layer images, the encoder 810 may determine prediction units and coding units of a tree structure in each largest coding unit, and may perform inter-prediction on each of the prediction units.

The video encoding apparatus 800 may encode an inter layer prediction error for predicting a current layer image by using an SAO. Thus, a prediction error of the current layer image may be encoded by using information regarding an SAO type and an offset based on a sample value distribution of the prediction error without having to encoding the prediction error for each sample location.

FIG. 8B illustrates a block diagram of a video decoding apparatus based on a coding unit having a tree structure 850, according to various embodiments.

The video decoding apparatus involving video prediction based on the coding unit according to the tree structure 850 includes a receiving and extracting unit 110, an image data and encoding information receiving and extracting unit 860, and a decoder 870. Hereinafter, for convenience of description, the video decoding apparatus involving video prediction based on a coding unit according to a tree structure 850 will be referred to as the ‘video decoding apparatus 850’.

Definitions of various terms, such as a coding unit, a depth, a prediction unit, a transformation unit, and information about various encoding modes, for decoding operations of the video decoding apparatus 850 are identical to those described with reference to FIG. 8A and the video encoding apparatus 800.

The receiving and extracting unit 860 receives and parses a bitstream of an encoded video. The image data and encoding information receiving and extracting unit 860 extracts encoded image data for each coding unit from the parsed bitstream, wherein the coding units have a tree structure according to each largest coding unit, and outputs the extracted image data to the decoder 870. The image data and encoding information receiving and extracting unit 860 may extract information about a maximum size of a coding unit of a current picture, from a header about the current picture, a sequence parameter set, or a picture parameter set.

Also, the image data and encoding information receiving and extracting unit 860 extracts, from the parsed bitstream, information about a coded depth and an encoding mode for the coding units having a tree structure according to each largest coding unit. The extracted information about the coded depth and the encoding mode is output to the decoder 870. That is, the image data in a bitstream is split into the largest coding unit so that the decoder 870 decodes the image data for each largest coding unit.

The information about the coded depth and the encoding mode according to the largest coding unit may be set for information about at least one coding unit corresponding to the coded depth, and information about an encoding mode may include information about a partition type of a corresponding coding unit corresponding to the coded depth, about a prediction mode, and a size of a transformation unit. Also, splitting information according to depths may be extracted as the information about the coded depth.

The information about the coded depth and the encoding mode according to each largest coding unit extracted by the image data and encoding information receiving and extracting unit 860 is information about a coded depth and an encoding mode determined to generate a minimum encoding error when an encoder, such as the video encoding apparatus 800 according to an embodiment, repeatedly performs encoding for each deeper coding unit according to depths according to each largest coding unit. Accordingly, the video decoding apparatus 850 may reconstruct an image by decoding data according to an encoding method that generates the minimum encoding error.

Since encoding information about the coded depth and the encoding mode according to an embodiment may be assigned to a predetermined data unit from among a corresponding coding unit, a prediction unit, and a minimum unit, the image data and encoding information receiving and extracting unit 860 may extract the information about the coded depth and the encoding mode according to the predetermined data units. The predetermined data units to which the same information about the coded depth and the encoding mode is assigned may be inferred to be the data units included in the same largest coding unit.

The decoder 870 reconstructs the current picture by decoding the image data in each largest coding unit based on the coded depth and the encoding mode information according to each of the largest coding units. That is, the decoder 870 may decode the encoded image data, based on a read partition type, a prediction mode, and a transformation unit for each coding unit from among the coding units having the tree structure included in each largest coding unit. A decoding process may include a prediction process including intra prediction and motion compensation, and an inverse transformation process.

The decoder 870 may perform intra prediction or motion compensation according to a partition and a prediction mode of each coding unit, based on the information about the partition type and the prediction mode of the prediction unit of the coding unit according to coded depths.

In addition, for inverse transformation for each largest coding unit, the decoder 870 may read information about a transformation unit according to a tree structure for each coding unit so as to perform inverse transformation based on transformation units for each coding unit. Due to the inverse transformation, a pixel value of a spatial domain of the coding unit may be reconstructed.

The decoder 870 may determine a coded depth of a current largest coding unit by using split information according to depths. If the split information specifies that image data is no longer split in the current depth, the current depth is the coded depth. Accordingly, the decoder 870 may decode the image data of the current largest coding unit by using the information about the partition type of the prediction unit, the prediction mode, and the size of the transformation unit for each coding unit corresponding to the current depth.

That is, data units containing the encoding information including the same split information may be gathered by observing the encoding information set assigned for the predetermined data unit from among the coding unit, the prediction unit, and the minimum unit, and the gathered data units may be considered to be one data unit to be decoded by the decoder 870 in the same encoding mode. As such, the current coding unit may be decoded by obtaining the information about the encoding mode for each coding unit.

The scalable video decoding apparatus 700 described with reference to FIG. 7B may include the video decoding apparatuses 850 corresponding to the number of views, so as to reconstruct reference layer images and current layer images by decoding a received reference layer imagestream and a received current layer imagestream.

When the reference layer imagestream is received, the decoder 870 of the video decoding apparatus 850 may split samples of the reference layer images, which are extracted from the reference layer imagestream by the receiving and extracting unit 860, into coding units according to a tree structure of a largest coding unit. The decoder 870 may perform motion compensation, based on prediction units for the inter-image prediction, on each of the coding units according to the tree structure of the samples of the reference layer images, and may reconstruct the reference layer images.

When the current layer imagestream is received, the decoder 870 of the video decoding apparatus 850 may split samples of the current layer images, which are extracted from the current layer imagestream by the receiving and extracting unit 860, into coding units according to a tree structure of a largest coding unit. The decoder 870 may perform motion compensation, based on prediction units for the inter-image prediction, on each of the coding units according to the tree structure of the samples of the current layer images, and may reconstruct the current layer images.

The receiving and extracting unit 860 may obtain an SAO type and an offset from the received current layer bitstream and may determine an SAO category according to a distribution of sample values for each sample of a current layer prediction image, thereby obtaining an offset for each SAO category by using the SAO type and the offset. Thus, the decoder 870 may compensate for an offset of a corresponding category for each sample of the current layer prediction image without receiving a prediction error for each sample, and may determine a reconstructed current layer image by referring to the compensated current layer prediction image.

Thus, the video decoding apparatus 850 may obtain information about at least one coding unit that generates the minimum encoding error when encoding is recursively performed for each largest coding unit, and may use the information to decode the current picture. That is, the coding units having the tree structure determined to be the optimum coding units in each largest coding unit may be decoded.

Accordingly, even if an image has high resolution or has an excessively large data amount, the image may be efficiently decoded and reconstructed by using a size of a coding unit and an encoding mode, which are adaptively determined according to characteristics of the image, by using optimal encoding mode information received from an encoding terminal.

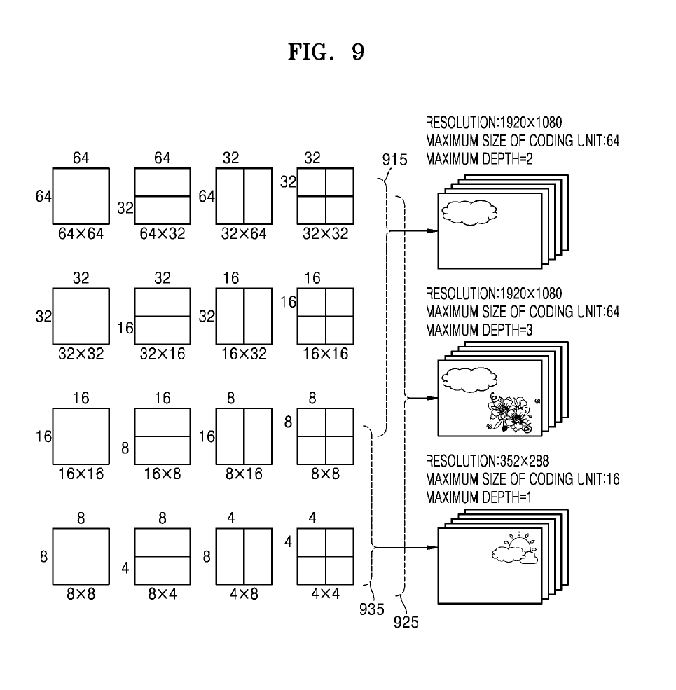

FIG. 9 illustrates a concept of coding units, according to various embodiments.

A size of a coding unit may be expressed by width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 910, a resolution is 1920×1080, a maximum size of a coding unit is 64, and a maximum depth is 2. In video data 920, a resolution is 1920×1080, a maximum size of a coding unit is 64, and a maximum depth is 3. In video data 930, a resolution is 352×288, a maximum size of a coding unit is 16, and a maximum depth is 1. The maximum depth shown in FIG. 15 denotes the total number of splits from a largest coding unit to a smallest coding unit.

If a resolution is high or a data amount is large, it is preferable that a maximum size of a coding unit is large so as to not only increase encoding efficiency but also to accurately reflect characteristics of an image. Accordingly, the maximum size of the coding unit of the video data 910 and 920 having a higher resolution than the video data 930 may be selected to 64.

Since the maximum depth of the video data 910 is 2, coding units 915 of the vide data 910 may include a largest coding unit having a long axis size of 64, and coding units having long axis sizes of 32 and 16 since depths are deepened to two layers by splitting the largest coding unit twice. On the other hand, since the maximum depth of the video data 930 is 1, coding units 935 of the video data 930 may include a largest coding unit having a long axis size of 16, and coding units having a long axis size of 8 since depths are deepened to one layer by splitting the largest coding unit once.

Since the maximum depth of the video data 920 is 3, coding units 925 of the video data 920 may include a largest coding unit having a long axis size of 64, and coding units having long axis sizes of 32, 16, and 8 since the depths are deepened to 3 layers by splitting the largest coding unit three times. As a depth deepens, an expression capability with respect to detailed information may be improved.

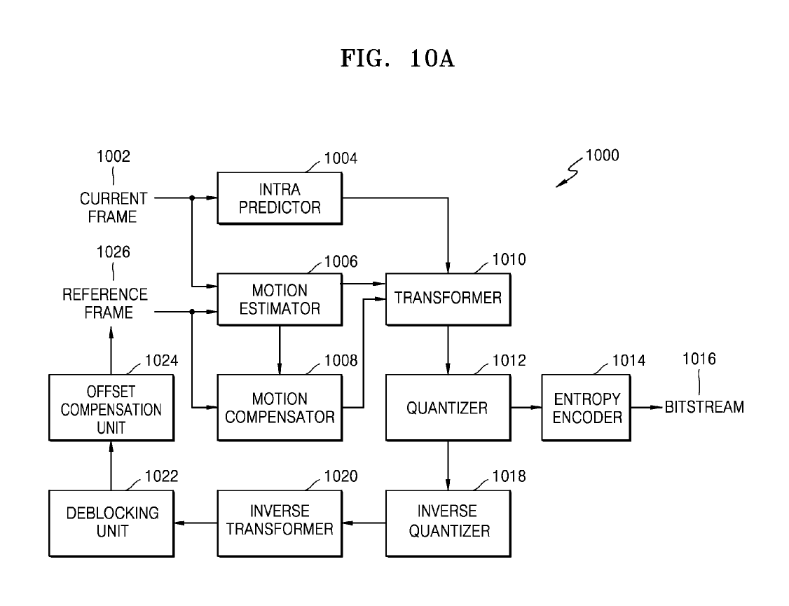

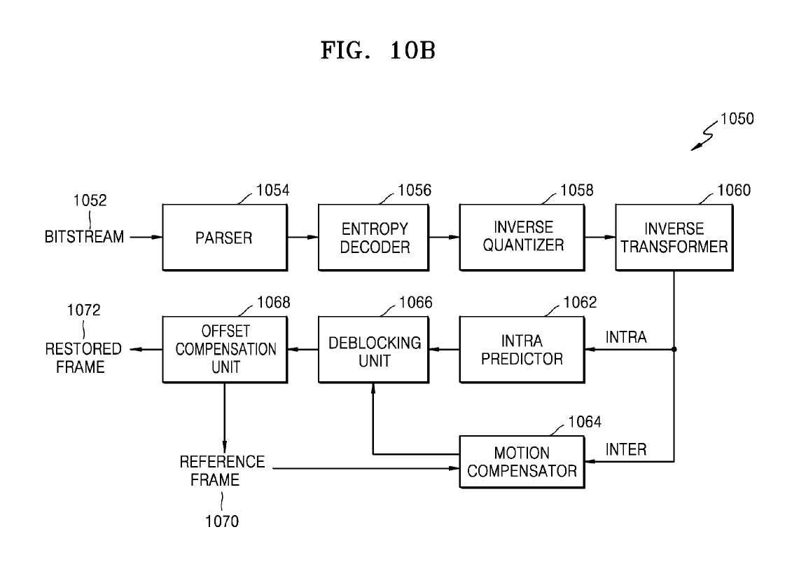

FIG. 10A illustrates a block diagram of an image encoder 1000 based on coding units, according to various embodiments.

The image encoder 1000 according to an embodiment includes operations that are performed by the encoder 910 of the video encoding apparatus 900 to encode image data. That is, an intra predictor 1004 performs intra prediction on coding units in an intra mode, from among a current frame 1002, and a motion estimator 1006 and a motion compensator 1008 perform inter estimation and motion compensation on coding units in an inter mode from among the current frame 1002 by using the current frame 1002 and a reference frame 1026.

Data output from the intra predictor 1004, the motion estimator 1006, and the motion compensator 1008 is output as quantized transformation coefficients through a transformer 1010 and a quantizer 1012. The quantized transformation coefficients are restored as data in a spatial domain through an inverse quantizer 1018 and an inverse transformer 1020, and the restored data in the spatial domain is output as the reference frame 1026 after being post-processed through a deblocking unit 1022 and an offset compensation unit 1024. The quantized transformation coefficients may be output as a bitstream 1016 through an entropy encoder 1014.

In order for the image encoder 1000 to be applied in the video encoding apparatus 900, all elements of the image encoder 1000, i.e., the intra predictor 1004, the motion estimator 1006, the motion compensator 1008, the transformer 1010, the quantizer 1012, the entropy encoder 1014, the inverse quantizer 1018, the inverse transformer 1020, the deblocking unit 1022, and the offset compensation unit 1024 perform operations based on each coding unit from among coding units having a tree structure while considering the maximum depth of each largest coding unit.

In particular, the intra predictor 1004, the motion estimator 1006, and the motion compensator 1008 determine partitions and a prediction mode of each coding unit from among the coding units having a tree structure while considering the maximum size and the maximum depth of a current largest coding unit, and the transformer 1010 determines the size of the transformation unit in each coding unit from among the coding units having a tree structure.

FIG. 10B illustrates a block diagram of an image decoder 1050 based on coding units, according to various embodiments.

A parser 1054 parses encoded image data to be decoded and information about encoding required for decoding from a bitstream 1052. The encoded image data is output as inverse quantized data through an entropy decoder 1056 and an inverse quantizer 1058, and the inverse quantized data is restored to image data in a spatial domain through an inverse transformer 1060.

An intra predictor 1062 performs intra prediction on coding units in an intra mode with respect to the image data in the spatial domain, and a motion compensator 1064 performs motion compensation on coding units in an inter mode by using a reference frame 1070.

The image data in the spatial domain, which passed through the intra predictor 1062 and the motion compensator 1064, may be output as a restored frame 1072 after being post-processed through a deblocking unit 1066 and an offset compensation unit 1068. Also, the image data that is post-processed through the deblocking unit 1066 and the offset compensation unit 1068 may be output as the reference frame 1070.

In order to decode the image data in the decoder 970 of the video decoding apparatus 1050, the image decoder 1050 according to an embodiment may perform operations that are performed after the parser 1054 performs an operation.

In order for the image decoder 1050 to be applied in the video decoding apparatus 950, all elements of the image decoder 1050, i.e., the parser 1054, the entropy decoder 1056, the inverse quantizer 1058, the inverse transformer 1060, the intra predictor 1062, the motion compensator 1064, the deblocking unit 1066, and the offset compensation unit 1068 perform operations based on coding units having a tree structure for each largest coding unit.

In particular, the intra predictor 1062 and the motion compensator 1064 perform operations based on partitions and a prediction mode for each of the coding units having a tree structure, and the inverse transformer 1060 perform operations based on a size of a transformation unit for each coding unit.

The encoding operation of FIG. 10A and the decoding operation of FIG. 10B describe in detail a video stream encoding operation and a video stream decoding operation in a single layer, respectively. Thus, if the scalable video encoding apparatus 600 of FIG. 6A encodes a video stream of two or more layers, the image encoder 1000 may be provided for each layer.

Similarly, if the scalable video decoding apparatus 700 of FIG. 7A decodes a video stream of two or more layers, the image decoder 1050 may be provided for each layer.

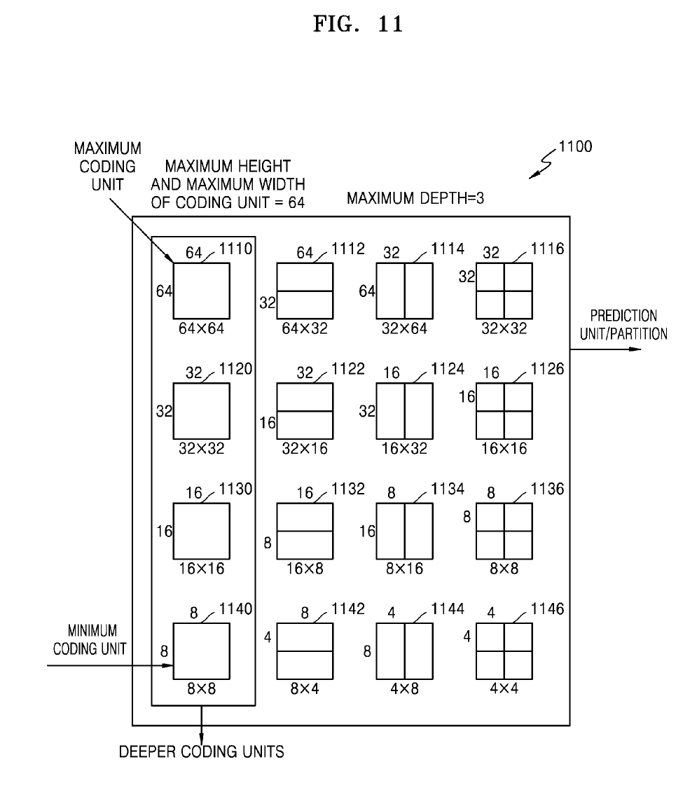

FIG. 11 illustrates a diagram illustrating deeper coding units according to depths, and partitions, according to various embodiments.

The video encoding apparatus 800 according to an embodiment and the video decoding apparatus 850 according to an embodiment use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 1100 of coding units, according to an embodiment, the maximum height and the maximum width of the coding units are each 64, and the maximum depth is 4. In this case, the maximum depth denotes the total number of times the coding unit is split from the largest coding unit to the smallest coding unit. Since a depth deepens along a vertical axis of the hierarchical structure 1100, a height and a width of the deeper coding unit are each split. Also, a prediction unit and partitions, which are bases for prediction encoding of each deeper coding unit, are shown along a horizontal axis of the hierarchical structure 1100.

That is, a coding unit 1110 is a largest coding unit in the hierarchical structure 1100, wherein a depth is 0 and a size, i.e., a height by width, is 64×64. The depth deepens along the vertical axis, and a coding unit 1120 having a size of 32×32 and a depth of 1, a coding unit 1130 having a size of 16×16 and a depth of 2, and a coding unit 1140 having a size of 8×8 and a depth of 3. The coding unit 1140 having the size of 8×8 and the depth of 3 is a smallest coding unit.

The prediction unit and the partitions of a coding unit are arranged along the horizontal axis according to each depth. That is, if the coding unit 1110 having the size of 64×64 and the depth of 0 is a prediction unit, the prediction unit may be split into partitions included in the coding unit 1110 having the size of 64×64, i.e. a partition 1110 having a size of 64×64, partitions 1112 having the size of 64×32, partitions 1114 having the size of 32×64, or partitions 1116 having the size of 32×32.

Equally, a prediction unit of the coding unit 1120 having the size of 32×32 and the depth of 1 may be split into partitions included in the coding unit 1120 having the size of 32×32, i.e. a partition 1120 having a size of 32×32, partitions 1122 having a size of 32×16, partitions 1124 having a size of 16×32, and partitions 1126 having a size of 16×16.

Equally, a prediction unit of the coding unit 1130 having the size of 16×16 and the depth of 2 may be split into partitions included in the coding unit 1130 having the size of 16×16, i.e. a partition 1130 having a size of 16×16, partitions 1132 having a size of 16×8, partitions 1134 having a size of 8×16, and partitions 1136 having a size of 8×8.

Equally, a prediction unit of the coding unit 1140 having the size of 8×8 and the depth of 3 may be split into partitions included in the coding unit 1140 having the size of 8×8, i.e. a partition 1140 having a size of 8×8, partitions 1142 having a size of 8×4, partitions 1144 having a size of 4×8, and partitions 1146 having a size of 4×4.

In order to determine a coded depth of the largest coding unit 1110, the encoder 810 of the video encoding apparatus 100 has to perform encoding on coding units respectively corresponding to depths included in the largest coding unit 1110.

The number of deeper coding units according to depths including data in the same range and the same size increases as the depth deepens. For example, four coding units corresponding to a depth of 2 are required to cover data that is included in one coding unit corresponding to a depth of 1. Accordingly, in order to compare results of encoding the same data according to depths, the data has to be encoded by using each of the coding unit corresponding to the depth of 1 and four coding units corresponding to the depth of 2.

In order to perform encoding according to each of the depths, a least encoding error that is a representative encoding error of a corresponding depth may be selected by performing encoding on each of prediction units of the coding units according to depths, along the horizontal axis of the hierarchical structure of coding units 1100. Also, the minimum encoding error may be searched for by comparing representative encoding errors according to depths, by performing encoding for each depth as the depth deepens along the vertical axis of the hierarchical structure of coding units 1100. A depth and a partition generating the minimum encoding error in the largest coding unit 1110 may be selected as a coded depth and a partition type of the largest coding unit 1110.

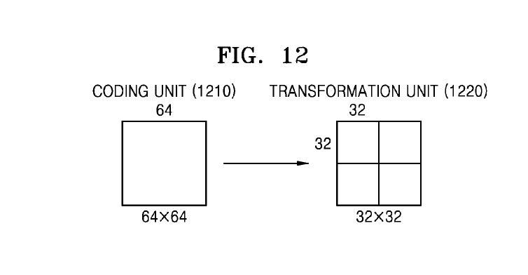

FIG. 12 illustrates a diagram for describing a relationship between a coding unit and transformation units, according to various embodiments.

The video encoding apparatus 800 according to an embodiment or the video decoding apparatus 850 according to an embodiment encodes or decodes an image according to coding units having sizes smaller than or equal to a largest coding unit for each largest coding unit.

Sizes of transformation units for transformation during an encoding process may be selected based on data units that are not larger than a corresponding coding unit.

For example, in the video encoding apparatus 800 or the video decoding apparatus 850, when a size of the coding unit 1210 is 64×64, transformation may be performed by using the transformation units 1220 having a size of 32×32.

Also, data of the coding unit 1210 having the size of 64×64 may be encoded by performing the transformation on each of the transformation units having the size of 32×32, 16×16, 8×8, and 4×4, which are smaller than 64×64, and then a transformation unit having the least coding error with respect to an original image may be selected.

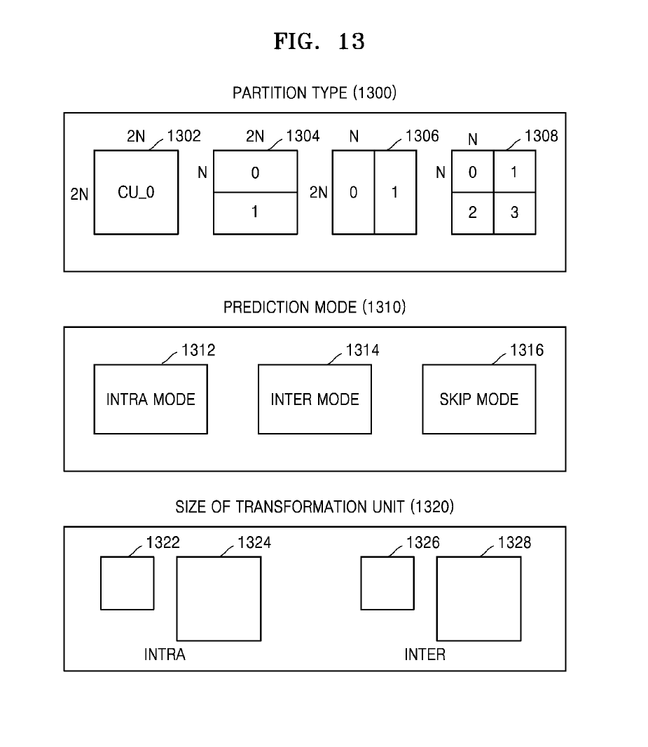

FIG. 13 illustrates a plurality of pieces of encoding information according to depths, according to various embodiments.

The output unit 820 of the video encoding apparatus 100 according to an embodiment may encode and transmit, as encoding mode information, partition type information 1300, prediction mode information 1310, and transformation unit size information 1320 for each coding unit corresponding to a coded depth.

The partition type information 1300 indicates information about a shape of a partition obtained by splitting a prediction unit of a current coding unit, wherein the partition is a data unit for prediction encoding the current coding unit. For example, a current coding unit CU_0 having a size of 2N×2N may be split into any one of a partition 1302 having a size of 2N×2N, a partition 1304 having a size of 2N×N, a partition 1306 having a size of N×2N, and a partition 1308 having a size of N×N. In this case, the partition type information 1300 about a current coding unit is set to indicate one of the partition 1302 having a size of 2N×2N, the partition 1304 having a size of 2N×N, the partition 1306 having a size of N×2N, and the partition 1308 having a size of N×N.

The prediction mode information 1310 indicates a prediction mode of each partition. For example, the prediction mode information 1310 may indicate a mode of prediction encoding performed on a partition indicated by the partition type information 1300, i.e., an intra mode 1312, an inter mode 1314, or a skip mode 1316.

The transformation unit size information 1320 represents a transformation unit to be based on when transformation is performed on a current coding unit. For example, the transformation unit may be one of a first intra transformation unit 1322, a second intra transformation unit 1324, a first inter transformation unit 1326, and a second inter transformation unit 1328.

The receiving and extracting unit 810 of the video decoding apparatus 850 may extract and use the partition type information 1300, the prediction mode information 1310, and the transformation unit size information 1320 for decoding, according to each deeper coding unit.

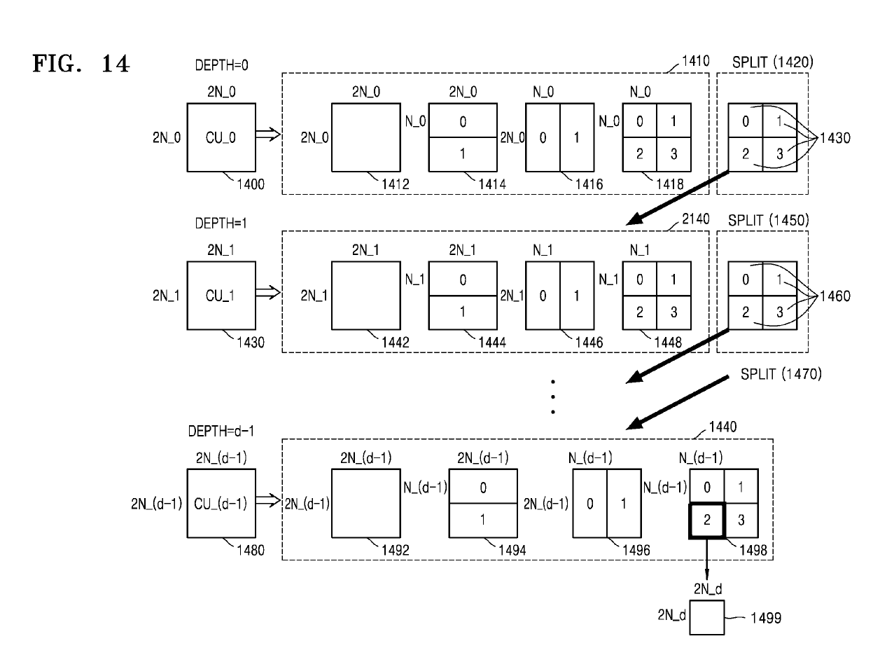

FIG. 14 illustrates deeper coding units according to depths, according to various embodiments.

Split information may be used to represent a change in a depth. The spilt information specifies whether a coding unit of a current depth is split into coding units of a lower depth.

A prediction unit 1410 for prediction encoding a coding unit 1400 having a depth of 0 and a size of 2N_0×2N_0 may include partitions of a partition type 1412 having a size of 2N_0×2N_0, a partition type 1414 having a size of 2N_0×N_0, a partition type 1416 having a size of N_0×2N_0, and a partition type 1418 having a size of N_0×N_0. Only the partition types 1412, 1414, 1416, and 1418 which are obtained by symmetrically splitting the prediction unit are illustrated, but as described above, a partition type is not limited thereto and may include asymmetrical partitions, partitions having a predetermined shape, and partitions having a geometrical shape.

According to each partition type, prediction encoding has to be repeatedly performed on one partition having a size of 2N_0×2N_0, two partitions having a size of 2N_0×N_0, two partitions having a size of N_0×2N_0, and four partitions having a size of N_0×N_0. The prediction encoding in an intra mode and an inter mode may be performed on the partitions having the sizes of 2N_0×2N_0, N_0×2N_0, 2N_0×N_0, and N_0×N_0. The prediction encoding in a skip mode may be performed only on the partition having the size of 2N_0×2N_0.

If an encoding error is smallest in one of the partition types 1412, 1414, and 1416 having the sizes of 2N_0×2N_0, 2N_0×N_0 and N_0×2N_0, the prediction unit 1410 may not be split into a lower depth.

If the encoding error is the smallest in the partition type 1418 having the size of N_0×N_0, a depth is changed from 0 to 1 and split is performed (operation 1420), and encoding may be repeatedly performed on coding units 1430 of a partition type having a depth of 2 and a size of N_0×N_0 so as to search for a minimum encoding error.

A prediction unit 1430 for prediction encoding the coding unit 1430 having a depth of 1 and a size of 2N_1×2N_1 (=N_0×N_0) may include a partition type 1442 having a size of 2N_1×2N_1, a partition type 1444 having a size of 2N_1×N_1, a partition type 1446 having a size of N_1×2N_1, and a partition type 1448 having a size of N_1×N_1.

If an encoding error is the smallest in the partition type 1448 having the size of N_1×N_1, a depth is changed from 1 to 2 and split is performed (in operation 1450), and encoding is repeatedly performed on coding units 1460 having a depth of 2 and a size of N_2×N_2 so as to search for a minimum encoding error.

When a maximum depth is d, deeper coding units according to depths may be set until when a depth corresponds to d−1, and split information may be set until when a depth corresponds to d−2. That is, when encoding is performed up to when the depth is d−1 after a coding unit corresponding to a depth of d−2 is split (in operation 1470), a prediction unit 1490 for prediction encoding a coding unit 1480 having a depth of d−1 and a size of 2N_(d−1)×2N_(d−1) may include partitions of a partition type 1492 having a size of 2N_(d−1)×2N_(d−1), a partition type 1494 having a size of 2N_(d−1)×N_(d−1), a partition type 1496 having a size of N_(d−1)×2N_(d−1), and a partition type 1498 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition types so as to search for a partition type generating a minimum encoding error.

Even when the partition type 1498 having the size of N_(d−1)×N_(d−1) has the minimum encoding error, since a maximum depth is d, a coding unit CU_(d−1) having a depth of d−1 is no longer split into a lower depth, and a coded depth for the coding units constituting a current largest coding unit 1400 is determined to be d−1 and a partition type of the current largest coding unit 1400 may be determined to be N_(d−1)×N_(d−1). Also, since the maximum depth is d, split information for a coding unit 1452 having a depth of d−1 is not set.

A data unit 1499 may be a ‘minimum unit’ for the current largest coding unit. A minimum unit according to the embodiment may be a square data unit obtained by splitting a smallest coding unit having a lowermost coded depth by 4. By performing the encoding repeatedly, the video encoding apparatus 100 according to the embodiment may select a depth having the least encoding error by comparing encoding errors according to depths of the coding unit 1400 to determine a coded depth, and set a corresponding partition type and a prediction mode as an encoding mode of the coded depth.

As such, the minimum encoding errors according to depths are compared in all of the depths of 0, 1, . . . , d−1, d, and a coded depth having the least encoding error may be determined as a depth. The coded depth, the partition type of the prediction unit, and the prediction mode may be encoded and transmitted as encoding mode information. Also, since a coding unit has to be split from a depth of 0 to the coded depth, only split information of the coded depth is set to ‘0’, and split information of depths excluding the coded depth is set to ‘1’.

The image data and encoding information receiving and extracting unit 860 of the video decoding apparatus 850 according to the embodiment may extract and use coded depth and prediction unit information about the coding unit 1400 so as to decode the coding unit 1412. The video decoding apparatus 850 according to the embodiment may determine a coded depth, in which split information is ‘0’, as a depth by using split information according to depths, and may use, for decoding, encoding mode information about the corresponding depth.

FIGS. 15, 16, and 17 illustrate a relationship between coding units, prediction units, and transformation units, according to various embodiments.

Coding units 1510 are deeper coding units according to coded depths determined by the video encoding apparatus 100, in a largest coding unit. Prediction units 1560 are partitions of prediction units of each of the coding units 1510 according to coded depths, and transformation units 1570 are transformation units of each of the coding units according to coded depths.

When a depth of a largest coding unit is 0 in the deeper coding units 1510, depths of coding units 1512 are 1, depths of coding units 1514, 1516, 1518, 1528, 1550, and 1552 are 2, depths of coding units 1520, 1522, 1524, 1526, 1530, 1532, and 1548 are 3, and depths of coding units 1540, 1542, 1544, and 1546 are 4.

Some partitions 1514, 1516, 1522, 1532, 1548, 1550, 1552, and 1554 from among the prediction units 1560 are obtained by splitting the coding unit. That is, partitions 1514, 1522, 1550, and 1554 are a partition type having a size of 2N×N, partitions 1516, 1548, and 1552 are a partition type having a size of N×2N, and a partition 1532 is a partition type having a size of N×N. Prediction units and partitions of the deeper coding units 1510 are smaller than or equal to each coding unit.

Transformation or inverse transformation is performed on image data of the coding unit 1552 in the transformation units 1570 in a data unit that is smaller than the coding unit 1552. Also, the coding units 1514, 1516, 1522, 1532, 1548, 1550, 1552, and 1554 in the transformation units 1560 are data units different from those in the prediction units 1560 in terms of sizes and shapes. That is, the video encoding apparatus 800 and the video decoding apparatus 850 according to the embodiments may perform intra prediction/motion estimation/motion compensation/and transformation/inverse transformation on an individual data unit in the same coding unit.

Accordingly, encoding is recursively performed on each of coding units having a hierarchical structure in each region of a largest coding unit so as to determine an optimum coding unit, and thus coding units according to a recursive tree structure may be obtained.

Encoding information may include split information about a coding unit, partition type information, prediction type information, and transformation unit size information. Table 1 below shows the encoding information that may be set by the video encoding apparatus 800 and the video decoding apparatus 850 according to the embodiments.

TABLE 1

| Split Information 0 | | | | | |
|---|---|---|---|---|---|
| (Encoding on Coding Unit having Size of 2N × 2N and Current Depth of d) | | | | | |
| | | | Size of Transformation Unit | | |
| | Partition Type | | Split Information 0 | Split Information 1 | |
| Prediction | Symmetrical | Asymmetrical | of Transformation | of Transformation | Split |
| Mode | Partition type | Partition type | Unit | Unit | Information 1 |
| Intra | 2N × 2N | 2N × nU | 2N × 2N | N × N | Repeatedly |
| Inter | 2N × N | 2N × nD | | (Symmetrical | Encode Coding |
| Skip (Only | N × 2N | nL × 2N | | Partition type) | Units having |
| 2N × 2N) | N × N | nR × 2N | | N/2 × N/2 | Lower Depth of |
| | | | | (Asymmetrical | d + 1 |
| | | | | Partition type)w | |

The output unit 820 of the video encoding apparatus 800 according to the embodiment may output the encoding information about the coding units having a tree structure, and the encoding information receiving and extracting unit 860 of the video decoding apparatus 850 according to the embodiment may extract the encoding information about the coding units having a tree structure from a received bitstream.

Split information specifies whether a current coding unit is split into coding units of a lower depth. If split information of a current depth d is 0, a depth, in which a current coding unit is no longer split into a lower depth, is a coded depth, and thus partition type information, prediction mode information, and transformation unit size information may be defined for the coded depth. If the current coding unit has to be further split according to the split information, encoding has to be independently performed on each of four split coding units of a lower depth.

A prediction mode may be one of an intra mode, an inter mode, and a skip mode. The intra mode and the inter mode may be defined in all partition types, and the skip mode may be defined only in a partition type having a size of 2N×2N.

The partition type information may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:3 and 3:1, and the asymmetrical partition types having the sizes of nL×2N and nR×2N may be respectively obtained by splitting the width of the prediction unit in 1:3 and 3:1.

The size of the transformation unit may be set to be two types in the intra mode and two types in the inter mode. That is, if split information of the transformation unit is 0, the size of the transformation unit may be 2N×2N, which is the size of the current coding unit. If split information of the transformation unit is 1, the transformation units may be obtained by splitting the current coding unit. Also, if a partition type of the current coding unit having the size of 2N×2N is a symmetrical partition type, a size of a transformation unit may be N×N, and if the partition type of the current coding unit is an asymmetrical partition type, the size of the transformation unit may be N/2×N/2.

The encoding information about coding units having a tree structure according to the embodiment may be assigned to at least one of a coding unit of a coded depth, a prediction unit, and a minimum unit. The coding unit of the coded depth may include at least one of a prediction unit and a minimum unit containing the same encoding information.

Accordingly, it is determined whether adjacent data units are included in the same coding unit corresponding to the coded depth by comparing encoding information of the adjacent data units. Also, a corresponding coding unit corresponding to a coded depth may be determined by using encoding information of a data unit, and thus a distribution of coded depths in a largest coding unit may be inferred.

Accordingly, if a current coding unit is predicted based on encoding information of adjacent data units, encoding information of data units in deeper coding units adjacent to the current coding unit may be directly referred to and used.

In another embodiment, if a current coding unit is predicted based on encoding information of adjacent data units, data units adjacent to the current coding unit may be searched by using encoded information of the data units, and the searched adjacent coding units may be referred for predicting the current coding unit.

FIG. 18 illustrates a relationship between a coding unit, a prediction unit, and a transformation unit, according to the encoding mode information of Table 1.

A largest coding unit 1800 includes coding units 1802, 1804, 1806, 1812, 1814, 1816, and 1818 of coded depths. Here, since the coding unit 1818 is a coding unit of a coded depth, split information may be set to 0. Partition type information of the coding unit 1818 having a size of 2N×2N may be set to be one of partition types including 2N×2N 1822, 2N×N 1824, N×2N 1826, N×N 1828, 2N×nU 1832, 2N×nD 1834, nL×2N 1836, and nR×2N 1838.

Transformation unit split information (TU size flag) is a type of a transformation index, and a size of a transformation unit corresponding to the transformation index may be changed according to a prediction unit type or partition type of the coding unit.

For example, when the partition type information is set to be one of symmetrical partition types 2N×2N 1822, 2N×N 1824, N×2N 1826, and N×N 1828, if the transformation unit split information is 0, a transformation unit 1842 having a size of 2N×2N is set, and if the transformation unit split information is 1, a transformation unit 1844 having a size of N×N may be set.

When the partition type information is set to be one of asymmetrical partition types 2N×nU 1832, 2N×nD 1834, nL×2N 1836, and nR×2N 1838, if the transformation unit split information (TU size flag) is 0, a transformation unit 1852 having a size of 2N×2N may be set, and if the transformation unit split information is 1, a transformation unit 1854 having a size of N/2×N/2 may be set.

The transformation unit split information (TU size flag) described above with reference to FIG. 18 is a flag having a value or 0 or 1, but the transformation unit split information according to an embodiment is not limited to a flag having 1 bit, and the transformation unit may be hierarchically split while the transformation unit split information increases in a manner of 0, 1, 2, 3 . . . etc., according to setting. The transformation unit split information may be an example of the transformation index.

In this case, the size of a transformation unit that has been actually used may be expressed by using the transformation unit split information according to the embodiment, together with a maximum size of the transformation unit and a minimum size of the transformation unit. The video encoding apparatus 100 according to the embodiment may encode maximum transformation unit size information, minimum transformation unit size information, and maximum transformation unit split information. The result of encoding the maximum transformation unit size information, the minimum transformation unit size information, and the maximum transformation unit split information may be inserted into an SPS. The video decoding apparatus 850 according to the embodiment may decode video by using the maximum transformation unit size information, the minimum transformation unit size information, and the maximum transformation unit split information.

For example, (a) if the size of a current coding unit is 64×64 and a maximum transformation unit size is 32×32, (a−1) then the size of a transformation unit may be 32×32 when a TU size flag is 0, (a−2) may be 16×16 when the TU size flag is 1, and (a−3) may be 8×8 when the TU size flag is 2.

As another example, (b) if the size of the current coding unit is 32×32 and a minimum transformation unit size is 32×32, (b−1) then the size of the transformation unit may be 32×32 when the TU size flag is 0. Here, the TU size flag cannot be set to a value other than 0, since the size of the transformation unit cannot be smaller than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizeIndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit may be defined by Equation (1):

CurrMinTuSize=max(MinTransformSize,RootTuSize/(2̂MaxTransformSizeIndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. That is, in Equation (1), ‘RootTuSize/(2̂MaxTransformSizeIndex)’ denotes a transformation unit size when the transformation unit size ‘RootTuSize’, when the TU size flag is 0, is split by the number of times corresponding to the maximum TU size flag, and ‘MinTransformSize’ denotes a minimum transformation size. Thus, a smaller value from among ‘RootTuSize/(2̂MaxTransformSizeIndex)^{’} and ‘MinTransformSize’ may be the current minimum transformation unit size ‘CurrMinTuSize’ that can be determined in the current coding unit.

According to an embodiment, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize,PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an embodiment, and a factor for determining the current maximum transformation unit size is not limited thereto.

According to the video encoding method based on coding units of a tree structure described above with reference to FIGS. 15 through 18, image data of a spatial domain is encoded in each of the coding units of the tree structure, and the image data of the spatial domain is reconstructed in a manner that decoding is performed on each largest coding unit according to the video decoding method based on the coding units of the tree structure, so that a video that is formed of pictures and picture sequences may be reconstructed. The reconstructed video may be reproduced by a reproducing apparatus, may be stored in a storage medium, or may be transmitted via a network.

The aforementioned embodiments may be written as computer programs and may be implemented in general-use digital computers that execute the programs by using a computer-readable recording medium. Examples of the computer-readable recording medium include magnetic storage media (e.g., ROM, floppy disks, hard disks, etc.), optical recording media (e.g., CD-ROMs, or DVDs), etc.

For convenience of description, the scalable video encoding methods and/or the video encoding method, which are described with reference to FIGS. 6A through 18, will be collectively referred to as ‘the scalable video encoding method of the present disclosure’. Also, the video decoding methods and/or the video decoding method, which are described with reference to FIGS. 6A through 18, will be collectively referred to as ‘the video decoding method of the present disclosure’.

Also, a video encoding apparatus including the scalable video encoding apparatus 600, the video encoding apparatus 800 or the image encoder 1000 which are described with reference to FIGS. 6A through 18 will be collectively referred to as a ‘video encoding apparatus of the present disclosure’. Also, a video decoding apparatus including the scalable video decoding apparatus 700, the video decoding apparatus 850, or the image decoder 1050 which are described with reference to FIGS. 6A through 18 will be collectively referred to as a ‘video decoding apparatus of the present disclosure’.

The computer-readable recording medium such as a disc 26000 that stores the programs according to an embodiment will now be described in detail.

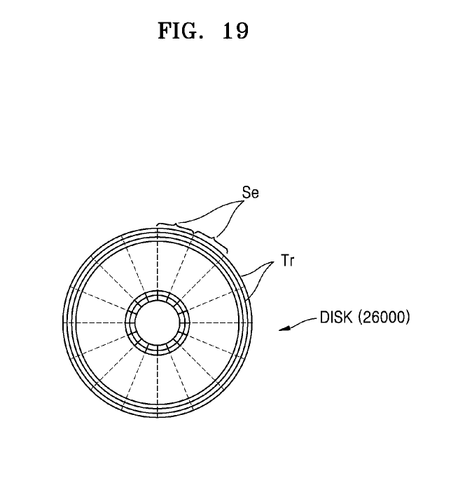

FIG. 19 illustrates a physical structure of the disc 26000 in which a program is stored, according to various embodiments. The disc 26000 described as the storage medium may be a hard drive, a compact disc-read only memory (CD-ROM) disc, a Blu-ray disc, or a digital versatile disc (DVD). The disc 26000 includes a plurality of concentric tracks Tr that are each divided into a specific number of sectors Se in a circumferential direction of the disc 26000. In a specific region of the disc 26000, a program that executes the quantized parameter determining method, the video encoding method, and the video decoding method described above may be assigned and stored.

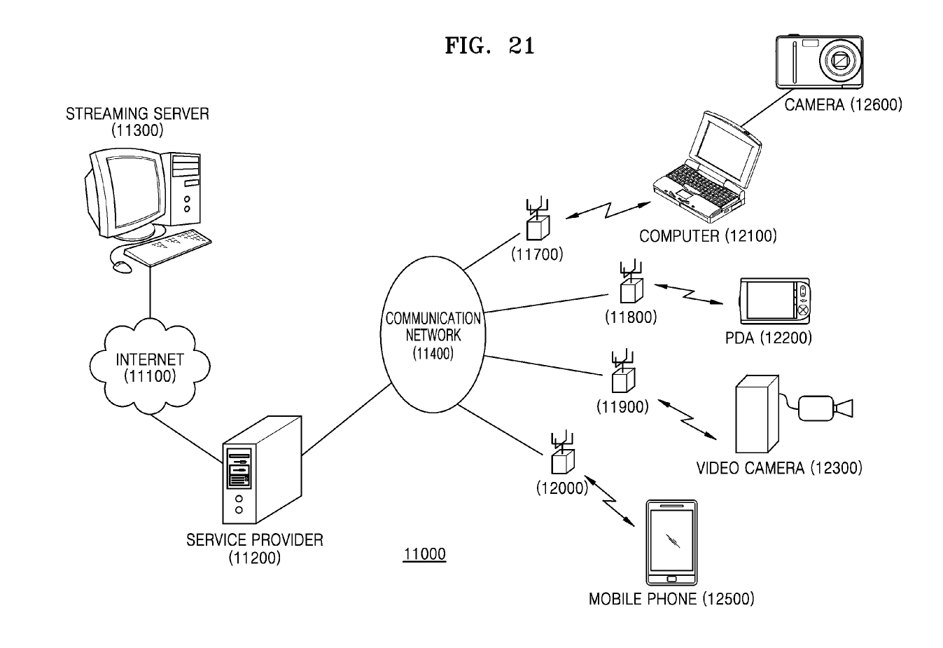

A computer system embodied using the storage medium that stores the program for executing the video encoding method and the video decoding method as described above will now be described with reference to FIG. 21.

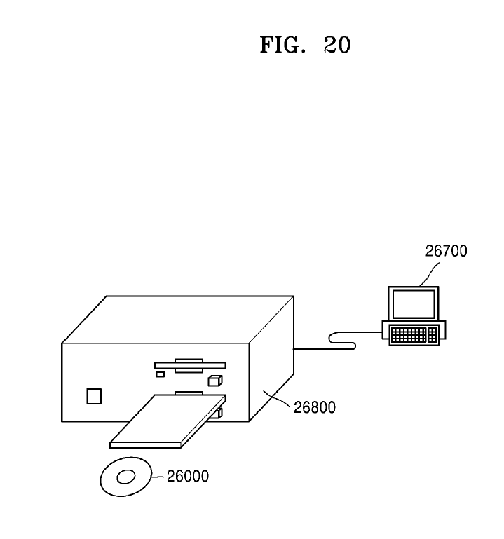

FIG. 20 illustrates a disc drive 26800 for recording and reading a program by using the disc 26000. A computer system 26700 may store a program that executes at least one of the video encoding method and the video decoding method of the present disclosure, in the disc 26000 via the disc drive 26800. In order to run the program stored in the disc 26000 in the computer system 26700, the program may be read from the disc 26000 and may be transmitted to the computer system 26700 by using the disc drive 26800.

The program that executes at least one of the video encoding method and the video decoding method of the present disclosure may be stored not only in the disc 26000 illustrated in FIGS. 19 and 21 but may also be stored in a memory card, a ROM cassette, or a solid state drive (SSD).

A system to which the video encoding method and the video decoding method according to the embodiments described above are applied will be described below.

FIG. 21 illustrates an overall structure of a content supply system 11000 for providing a content distribution service. A service area of a communication system is divided into predetermined-sized cells, and wireless base stations 11700, 11800, 11900, and 12000 are installed in these cells, respectively.

The content supply system 11000 includes a plurality of independent devices. For example, the plurality of independent devices, such as a computer 12100, a personal digital assistant (PDA) 12200, a video camera 12300, and a mobile phone 12500, are connected to the Internet 11100 via an internet service provider 11200, a communication network 11400, and the wireless base stations 11700, 11800, 11900, and 12000.

However, the content supply system 11000 is not limited to as illustrated in FIG. 21, and devices may be selectively connected thereto. The plurality of independent devices may be directly connected to the communication network 11400, not via the wireless base stations 11700, 11800, 11900, and 12000.

The video camera 12300 is an imaging device, e.g., a digital video camera, which is capable of capturing video images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The video camera 12300 may be connected to a streaming server 11300 via the wireless base station 11900 and the communication network 11400. The streaming server 11300 allows content received from a user via the video camera 12300 to be streamed via a real-time broadcast. The content received from the video camera 12300 may be encoded by the video camera 12300 or the streaming server 11300. Video data captured by the video camera 12300 may be transmitted to the streaming server 11300 via the computer 12100.

Video data captured by a camera 12600 may also be transmitted to the streaming server 11300 via the computer 12100. The camera 12600 is an imaging device capable of capturing both still images and video images, similar to a digital camera. The video data captured by the camera 12600 may be encoded using the camera 12600 or the computer 12100. Software that performs encoding and decoding video may be stored in a computer-readable recording medium, e.g., a CD-ROM disc, a floppy disc, a hard disc drive, an SSD, or a memory card, which may be accessed by the computer 12100.

If video is captured by a camera mounted in the mobile phone 12500, video data may be received from the mobile phone 12500.

The video data may be encoded by a large scale integrated circuit (LSI) system installed in the video camera 12300, the mobile phone 12500, or the camera 12600.

The content supply system 11000 may encode content data recorded by a user using the video camera 12300, the camera 12600, the mobile phone 12500, or another imaging device, e.g., content recorded during a concert, and may transmit the encoded content data to the streaming server 11300. The streaming server 11300 may transmit the encoded content data in a type of streaming content to other clients that request the content data.

The clients are devices capable of decoding the encoded content data, e.g., the computer 12100, the PDA 12200, the video camera 12300, or the mobile phone 12500. Thus, the content supply system 11000 allows the clients to receive and reproduce the encoded content data. Also, the content supply system 11000 allows the clients to receive the encoded content data and decode and reproduce the encoded content data in real time, thereby enabling personal broadcasting.

The video encoding apparatus and the video decoding apparatus of the present disclosure may be applied to encoding and decoding operations of the plurality of independent devices included in the content supply system 11000.

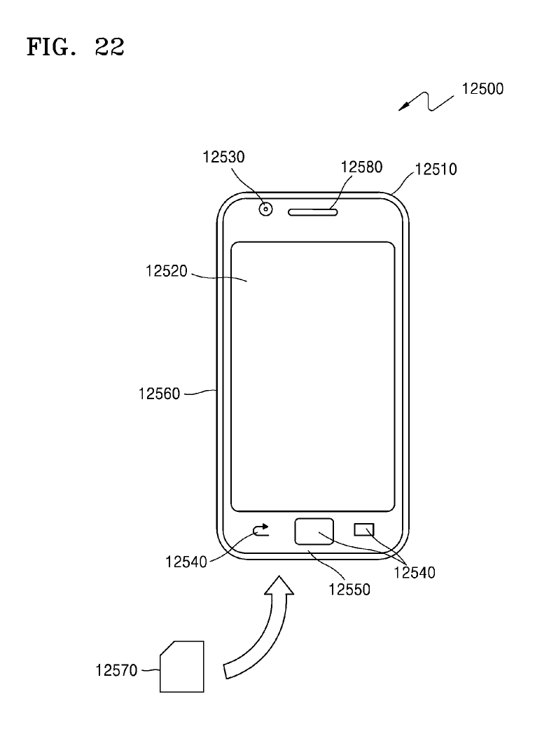

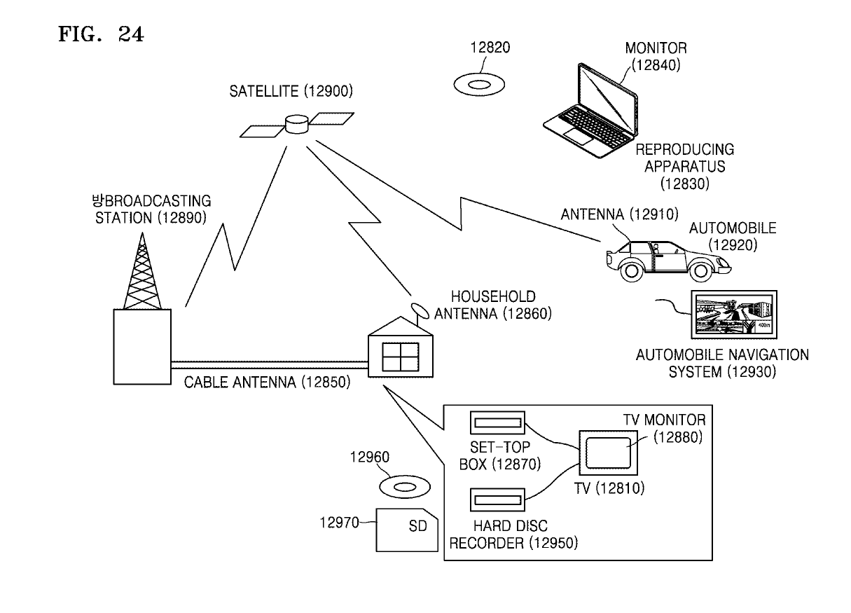

With reference to FIGS. 22 and 24, the mobile phone 12500 included in the content supply system 11000 according to an embodiment will now be described in detail.

FIG. 22 illustrates an external structure of the mobile phone 12500 to which the video encoding apparatus and the video decoding apparatus of the present disclosure are applied, according to various embodiments. The mobile phone 12500 may be a smart phone, the functions of which are not limited and a large number of the functions of which may be changed or expanded.

The mobile phone 12500 includes an internal antenna 12510 via which a radio-frequency (RF) signal may be exchanged with the wireless base station 12000, and includes a display screen 12520 for displaying images captured by a camera 12530 or images that are received via the antenna 12510 and decoded, e.g., a liquid crystal display (LCD) or an organic light-emitting diode (OLED) screen. The mobile phone 12500 includes an operation panel 12540 including a control button and a touch panel. If the display screen 12520 is a touch screen, the operation panel 12540 further includes a touch sensing panel of the display screen 12520. The mobile phone 12500 includes a speaker 12580 for outputting voice and sound or another type of a sound output unit, and a microphone 12550 for inputting voice and sound or another type of a sound input unit. The mobile phone 12500 further includes the camera 12530, such as a charge-coupled device (CCD) camera, to capture video and still images. The mobile phone 12500 may further include a storage medium 12570 for storing encoded/decoded data, e.g., video or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

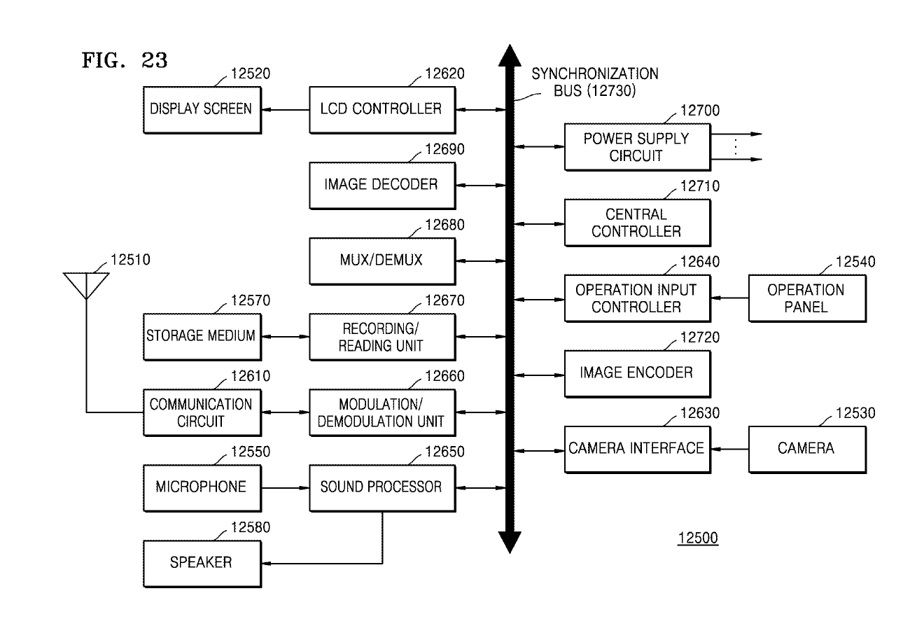

FIG. 23 illustrates an internal structure of the mobile phone 12500. In order to systemically control each of parts of the mobile phone 12500 including the display screen 12520 and the operation panel 12540, a power supply circuit 12700, an operation input controller 12640, an image encoder 12720, a camera interface 12630, an LCD controller 12620, an image decoder 12690, a multiplexer/demultiplexer 12680, a recorder/reader 12670, a modulator/demodulator 12660, and a sound processor 12650 are connected to a central controller 12710 via a synchronization bus 12730.

If a user operates a power button and sets from a ‘power off’ state to a ‘power on’ state, the power supply circuit 12700 supplies power to all the parts of the mobile phone 12500 from a battery pack, thereby setting the mobile phone 12500 to an operation mode.

The central controller 12710 includes a CPU, a read-only memory (ROM), and a random access memory (RAM).

While the mobile phone 12500 transmits communication data to the outside, a digital signal is generated by the mobile phone 12500 under control of the central controller 12710. For example, the sound processor 12650 may generate a digital sound signal, the image encoder 12720 may generate a digital image signal, and text data of a message may be generated via the operation panel 12540 and the operation input controller 12640. When a digital signal is transmitted to the modulator/demodulator 12660 by control of the central controller 12710, the modulator/demodulator 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is transformed into a digital sound signal by the sound processor 12650 under control of the central controller 12710. The digital sound signal may be transformed into a transformation signal via the modulator/demodulator 12660 and the communication circuit 12610, and may be transmitted via the antenna 12510.

When a text message, e.g., email, is transmitted during a data communication mode, text data of the text message is input via the operation panel 12540 and is transmitted to the central controller 12610 via the operation input controller 12640. By control of the central controller 12610, the text data is transformed into a transmission signal via the modulator/demodulator 12660 and the communication circuit 12610 and is transmitted to the wireless base station 12000 via the antenna 12510.

In order to transmit image data during the data communication mode, image data captured by the camera 12530 is provided to the image encoder 12720 via the camera interface 12630. The captured image data may be directly displayed on the display screen 12520 via the camera interface 12630 and the LCD controller 12620.

A structure of the image encoder 12720 may correspond to that of the video encoding apparatus described above. The image encoder 12720 may transform the image data received from the camera 12530 into compressed and encoded image data according to the aforementioned video encoding method, and then output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be transmitted to the multiplexer/demultiplexer 12680.

The multiplexer/demultiplexer 12680 multiplexes the encoded image data received from the image encoder 12720, together with the sound data received from the sound processor 12650. A result of multiplexing the data may be transformed into a transmission signal via the modulator/demodulator 12660 and the communication circuit 12610, and may then be transmitted via the antenna 12510.

While the mobile phone 12500 receives communication data from the outside, frequency recovery and analog-to-digital conversion (A/D) are performed on a signal received via the antenna 12510 to transform the signal into a digital signal. The modulator/demodulator 12660 modulates a frequency band of the digital signal. The frequency-band modulated digital signal is transmitted to the image decoder 12690, the sound processor 12650, or the LCD controller 12620, according to the type of the digital signal.

During the conversation mode in which communication data is received from the outside, the mobile phone 12500 amplifies a signal received via the antenna 12510, and obtains a digital sound signal by performing frequency conversion and A/D on the amplified signal. A received digital sound signal is transformed into an analog sound signal via the modulator/demodulator 12660 and the sound processor 12650, and the analog sound signal is output via the speaker 12580, by control of the central controller 12710.

When during the data communication mode, data of a video file accessed at an Internet website is received, a signal received from the wireless base station 12000 via the antenna 12510 is output as multiplexed data via the modulator/demodulator 12660, and the multiplexed data is transmitted to the multiplexer/demultiplexer 12680.

In order to decode the multiplexed data received via the antenna 12510, the multiplexer/demultiplexer 12680 demultiplexes the multiplexed data into an encoded video data stream and an encoded audio data stream. Via the synchronization bus 12730, the encoded video data stream and the encoded audio data stream are provided to the image decoder 12690 and the sound processor 12650, respectively.

A structure of the image decoder 12690 may correspond to that of the video decoding apparatus described above. The image decoder 12690 may decode the encoded video data to obtain reconstructed video data and provide the reconstructed video data to the display screen 12520 via the LCD controller 12620, by using the aforementioned video decoding method of the present disclosure.

Thus, the video data of the video file accessed at the Internet website may be displayed on the display screen 12520. At the same time, the sound processor 12650 may transform audio data into an analog sound signal, and may provide the analog sound signal to the speaker 12580.

Thus, audio data contained in the video file accessed at the Internet website may also be reproduced via the speaker 12580.

The mobile phone 12500 or another type of communication terminal may be a transceiving terminal including both the video encoding apparatus and the video decoding apparatus of the present disclosure, may be a transmitting terminal including only the video encoding apparatus of the present disclosure, or may be a receiving terminal including only the video decoding apparatus of the present disclosure.

A communication system of the present disclosure is not limited to the communication system described above with reference to FIG. 21. For example, FIG. 24 illustrates a digital broadcasting system employing a communication system, according to various embodiments.

The digital broadcasting system of FIG. 24 may receive a digital broadcast transmitted via a satellite or a terrestrial network by using the video encoding apparatus and the video decoding apparatus of the present disclosure.

In more detail, a broadcasting station 12890 transmits a video data stream to a communication satellite or a broadcasting satellite 12900 by using radio waves. The broadcasting satellite 12900 transmits a broadcast signal, and the broadcast signal is transmitted to a satellite broadcast receiver via a household antenna 12860. In every house, an encoded video stream may be decoded and reproduced by a TV receiver 12810, a set-top box 12870, or another device.

When the video decoding apparatus of the present disclosure is implemented in a reproducing apparatus 12830, the reproducing apparatus 12830 may parse and decode an encoded video stream recorded on a storage medium 12820 such as a disc or a memory card so as to reconstruct digital signals. Thus, the reconstructed video signal may be reproduced, for example, on a monitor 12840.

In the set-top box 12870 connected to the antenna 12860 for a satellite/terrestrial broadcast or a cable antenna 12850 for receiving a cable television (TV) broadcast, the video decoding apparatus of the present disclosure may be installed. Data output from the set-top box 12870 may also be reproduced on a TV monitor 12880.

As another example, the video decoding apparatus of the present disclosure may be installed in the TV receiver 12810 instead of the set-top box 12870.

An automobile 12920 that has an appropriate antenna 12910 may receive a signal transmitted from the satellite 12900 or the wireless base station 11700. A decoded video may be reproduced on a display screen of an automobile navigation system 12930 installed in the automobile 12920.

A video signal may be encoded by the video encoding apparatus of the present disclosure and may then be recorded to and stored in a storage medium. In more detail, an image signal may be stored in a DVD disc 12960 by a DVD recorder or may be stored in a hard disc by a hard disc recorder 12950. As another example, the video signal may be stored in an SD card 12970. If the hard disc recorder 12950 includes the video decoding apparatus according to the exemplary embodiment, a video signal recorded on the DVD disc 12960, the SD card 12970, or another storage medium may be reproduced on the TV monitor 12880.

The automobile navigation system 12930 may not include the camera 12530, the camera interface 12630, and the image coding unit 12720 of FIG. 23. For example, the computer 12100 and the TV receiver 12810 may not include the camera 12530, the camera interface 12630, or the image coding unit 12720 of FIG. 23.

In this regard, the user terminal may include the video decoding apparatus of the present disclosure as described above with reference to FIGS. 1A through 18. As another example, the user terminal may include the video encoding apparatus of the present disclosure as described above with reference to FIGS. 1A through 18. Alternatively, the user terminal may include both the video decoding apparatus of the present disclosure and the video encoding apparatus of the present disclosure as described above with reference to FIGS. 1A through 18.

Various applications of the video encoding method, the video decoding method, the video encoding apparatus, and the video decoding apparatus according to the aforementioned embodiments have been described above with reference to FIGS. 1A through 18. However, various applications of the video encoding method, the video decoding method, the video encoding apparatus, and the video decoding apparatus according to the aforementioned embodiments are not limited to the embodiments described above with reference FIGS. 1A through 18.

While this disclosure has been particularly shown and described with reference to embodiments thereof, it will be understood by one of ordinary skill in the art that various changes in form and details may be made therein without departing from the spirit and scope of the disclosure as defined by the appended claims. The disclosed embodiments should be considered in a descriptive sense only and not for purposes of limitation. Therefore, the scope of the disclosure is defined not by the detailed description of the disclosure but by the appended claims, and all differences within the scope will be construed as being included in the present disclosure.

1. A video decoding method comprising:
obtaining, from a bitstream, upsampling phase set information indicating whether a phase of samples comprised in a current layer is adjusted;
when the phase is adjusted according to the upsampling phase set information, obtaining a luma vertical phase difference, a luma horizontal phase difference, a chroma vertical phase difference, and a chroma horizontal phase difference from the bitstream; and
determining a prediction picture of the current layer by upsampling a reference layer based on the luma vertical phase difference, the luma horizontal phase difference, the chroma vertical phase difference, and the chroma horizontal phase difference,
wherein
a phase of luma samples comprised in the prediction picture is adjusted according to the luma vertical phase difference and the luma horizontal phase difference,
a phase of chroma samples comprised in the prediction picture is adjusted according to the chroma vertical phase difference and the chroma horizontal phase difference, and
the luma vertical phase difference and the chroma vertical phase difference are determined according to a scanning scheme with respect to the reference layer.

2. The video decoding method of claim 1, wherein
the luma vertical phase difference and the chroma vertical phase difference are determined according to the scanning scheme with respect to the reference layer and an alignment scheme with respect to the reference layer and the current layer, and
the alignment scheme comprises a zero-phase alignment scheme that involves aligning the reference layer and the current layer, based on top-left portions of the reference layer and the current layer, and a symmetric alignment scheme that involves aligning the reference layer and the current layer, based on a center of the reference layer and the current layer.

3. The video decoding method of claim 1, further comprising:
obtaining, from the bitstream, reference layer size information, reference layer offset information, current layer size information, and current layer offset information, wherein the reference layer size information indicates a height and width of the reference layer, the reference layer offset information defines a reference region of the reference layer which is used in inter-layer prediction, the current layer size information indicates a height and width of the current layer, and the current layer offset information defines an expanded reference region of the current layer which corresponds to the reference region;
determining a size of the reference region from the reference layer size information and the reference layer offset information;
determining a size of the expanded reference region from the current layer size information and the current layer offset information; and
determining a scale ratio indicating a ratio of the reference region to the expanded reference region, based on the size of the reference region and the size of the expanded reference region,
wherein the determining of the prediction picture comprises determining the prediction picture by upsampling a reference picture based on the luma vertical phase difference, the luma horizontal phase difference, the chroma vertical phase difference, the chroma horizontal phase difference, the reference layer offset information, the current layer offset information, and the scale ratio.

4. The video decoding method of claim 1, further comprising:
obtaining, from the bitstream, residual data comprising a difference value between sample values comprised in the current layer and sample values comprised in a reference picture of the current layer; and
reconstructing a current picture by using the residual data and the prediction picture.

5. A video decoding apparatus comprising:
a receiving and extracting unit configured to obtain, from a bitstream, upsampling phase set information indicating whether a phase of samples comprised in a current layer is adjusted, and when the phase is adjusted according to the upsampling phase set information, to obtain a luma vertical phase difference, a luma horizontal phase difference, a chroma vertical phase difference, and a chroma horizontal phase difference from the bitstream; and
a decoder configured to determine a prediction picture of the current layer by upsampling a reference layer based on the luma vertical phase difference, the luma horizontal phase difference, the chroma vertical phase difference, and the chroma horizontal phase difference,
wherein
a phase of luma samples comprised in the prediction picture is adjusted according to the luma vertical phase difference and the luma horizontal phase difference,
a phase of chroma samples comprised in the prediction picture is adjusted according to the chroma vertical phase difference and the chroma horizontal phase difference, and
the luma vertical phase difference and the chroma vertical phase difference are determined according to a scanning scheme with respect to the reference layer.

6. The video decoding apparatus of claim 5, wherein
the luma vertical phase difference and the chroma vertical phase difference are determined according to the scanning scheme with respect to the reference layer and an alignment scheme with respect to the reference layer and the current layer, and
the alignment scheme comprises a zero-phase alignment scheme that involves aligning the reference layer and the current layer, based on top-left portions of the reference layer and the current layer, and a symmetric alignment scheme that involves aligning the reference layer and the current layer, based on a center of the reference layer and the current layer.

7. The video decoding apparatus of claim 5, wherein
the receiving and extracting unit is further configured to obtain, from the bitstream, reference layer size information, reference layer offset information, current layer size information, and current layer offset information, wherein the reference layer size information indicates a height and width of the reference layer, the reference layer offset information defines a reference region of the reference layer which is used in inter-layer prediction, the current layer size information indicates a height and width of the current layer, and the current layer offset information defines an expanded reference region of the current layer which corresponds to the reference region, and
the decoder is further configured to determine a size of the reference region from the reference layer size information and the reference layer offset information, to determine a size of the expanded reference region from the current layer size information and the current layer offset information, to determine a scale ratio indicating a ratio of the reference region to the expanded reference region, based on the size of the reference region and the size of the expanded reference region, and to determine the prediction picture by upsampling a reference picture based on the luma vertical phase difference, the luma horizontal phase difference, the chroma vertical phase difference, the chroma horizontal phase difference, the reference layer offset information, the current layer offset information, and the scale ratio.

8. The video decoding apparatus of claim 5, wherein the receiving and extracting unit is further configured to obtain, from the bitstream, residual data comprising a difference value between sample values comprised in the current layer and sample values comprised in a reference picture of the current layer, and to reconstruct a current picture by using the residual data and the prediction picture.

9. A video encoding method comprising:
determining a scanning scheme with respect to a current layer and a reference layer;
when the current layer is scanned according to a progressive scanning scheme and the reference layer is scanned according to an interlaced scanning scheme, determining a field of the reference layer;
determining a luma vertical phase difference, a luma horizontal phase difference, a chroma vertical phase difference, and a chroma horizontal phase difference for adjusting a phase of a luma sample and chroma samples comprised in a prediction picture of the current layer based on the scanning scheme and the field of the reference layer;
determining a prediction picture of the current layer by upsampling the reference layer, based on the luma vertical phase difference, the luma horizontal phase difference, the chroma vertical phase difference, and the chroma horizontal phase difference;
determining residual data comprising difference values between sample values of the current layer and sample values of the prediction picture of the current layer; and
outputting a bitstream comprising the luma vertical phase difference, the luma horizontal phase difference, the chroma vertical phase difference, the chroma horizontal phase difference, and the residual data.

10. (canceled)

11. A computer-readable recording medium having recorded thereon a program for executing the video decoding method of claim 1.

12. A computer-readable recording medium having recorded thereon a program for executing the video encoding method of claim 9.
